(19) United States
(12) Patent Application Publication
(10) Pub. No.: US 2008/0297878 A1
(43) Pub. Date: Dec. 4, 2008

(54) Compositions, methods and systems for making and using electronic paper

(75) Inventors: R. Malcolm Brown, Austin, TX (US); Yuyu Sun, Austin, TX (US); Robert Wenz, Austin, TX (US)

Correspondence Address: CHALKER FLORES, LLP, 2711 LBJ FRWY, Suite 1036, DALLAS, TX, 75234, US

(73) Assignee: Board Of Regents, The University of Texas System, Austin, TX (US)

(21) Appl. No.: 11/523,304

(22) Filed: Sep. 19, 2006

Related U.S. Application Data
(63) Continuation-in-part of application No. 10/957,258, filed on Oct. 1, 2004.
(60) Provisional application No. 60/718,532, filed on Sep. 19, 2005.
(60) Provisional application No. 60/507,861, filed on Oct. 1, 2003.

(51) Int. Cl. G02F 1/163; G02F 1/01; G02F 1/15

(52) U.S. Cl. 359/263; 359/240; 359/265

(57) ABSTRACT

The present invention is a device, method and system for making a display and displaying information that includes a fibrous organic substrate, e.g., multiribbon cellulose or cellulose substrate, and a variable reflectivity dye disposed in the fibrous substrate, wherein the reflectivity of the dye is modulated in situ. The display device may use a dye selected from an electrochromic, a thermochromic, a magnetochromic, an ionochromic, a light sensitive, a fluorescent, a fluorescent effect energy transfer dye or combinations thereof and may be used as high storage, high contrast and/or high definition paper.

This application claims priority to U.S. Provisional Patent Application Ser. No. 60/718,532, filed Sep. 19, 2005. Without limiting the scope of the invention, its background is described in connection with display devices controlled electronically, as an example.

### BACKGROUND OF THE INVENTION

### Technical Field of the Invention

The present invention relates in general to the field of display device, and more particularly, to a cellulose-based display device a method of manufacturing the same.

The terms ‘electronic paper’ and ‘electronic ink’ have been widely used in recent years. Although applied in diverse contexts, these terms are mainly dedicated to the electronic display media that has been developed in an attempt to match the essential qualities of paper. Therefore, electronic paper/ink when used for visual and imaging applications may be called with the general term, “paper-like display” to distinguish it from other applications. “Paper-like display” is a new concept introduced for little more than a decade. With the “Electronic paper” getting closer to the paper properties, it has been suggested that such electronic information displays may replace the printed-paper page. However, it is not simply a question of emulating the paper medium, but of identifying the places where there is a real disparity and using them to motivate new advances in the electronic presentation of information.

There have been numerous attempts to realize the dream of electronic paper. Several companies have attempted to develop an advanced display which is flexible, portable, and available to the population at throwaway prices. Three of these major efforts namely E-Ink, Gyricon and Kent Graphics. Several approaches have been developed for potential applications of E-paper including: thermochromism, electrochromic, electroluminescent polymers and magnetic particle systems. Sprague, R., “The present and future of Gyricon electronic paper display”, Xerox PARC, Palo Alto, Calif., USA, The international conference on digital printing technologies, IS&T's NIP 17, Sep. 30-Oct. 5, 2001, Fort Lauderdale, Fla., USA, pp. 519-522. Howard, M. E., “Gyricon electric paper”, SID International Symposium, Digest of Technical Reports, Anaheim, Calif., USA, May 17-22, 1998. http://www.gyriconmedia.com. Dalisa, A. L., “Electrophoretic display technology”, IEEE transactions on electron devices, vol. ED-24, Nov. 7, 1997, pp. 827-834. Chen, Y., et al, “A conformable electronic ink display using a foil-based a-Si TFT array”, E Ink Corp., MA, USA. http://www.eink.com, Butler, D., “Electronic ink for current issues”, Nature, vol. 411, May 3, 2001, p. 5. http://www.kentdisplays.com/support/features.htm

E-Ink is a technology based on electrophoretics that uses microcapsules, ˜30-300 μm in diameter, for encasing electrophoretic materials. These spheres are tightly packed between 2 plastic sheets. The spheres contain tiny white pigment chips, suspended in a blue-black liquid dye. Applying a field moves the particles, and the microcapsules can be switched into reflecting or absorbing mode by applying a positive or negative voltage across electrodes. However, the resolution is limited by size and spacing of spheres or microcapsules.

Gyricon is a product of Gyricon Media, a spin-off of Xerox located at the Palo Alto Research Center. Gyricon displays are made of millions of bichromal beads embedded between 2 plastic sheets by a flexible elastomeric matrix of oil filled cavities. The beads have contrasting hemispheres, white on one side (highly reflective) and black on other (absorbs light). The beads reside in their cavities, and on application of a voltage, they can present one or the other side to the viewer. An intermediate level switching voltage can produce gray-scale images. The plastic sheets can be produced in rolls like old fashioned paper while the balls are made by spraying molten wax-like plastics on opposite sides of a spinning disk. Ball diameters are determined by spinning speeds. A problem with this system is the lack of threshold voltage to change states, which in turn, leads to the lack of resolution. Also, since each pixel has to be addressed directly, this makes the display control electronics very complex. These technologies are still in the early stage of development, and there are a number of problems to be overcome before either E-ink or Gyricon can be used for varied applications.

Kent Displays are based on a kind of a liquid crystal display (LCD), which is called a cholesteric LCD because the liquid crystal material which it uses was derived from actual animal cholesterol. Cholesteric LCD material is sandwiched between two conducting electrodes and can be switched between two stable states—focal conic and planar states. By selectively reflecting different wavelengths, they produce color. Unlike, TN-LCDs used in laptops today, cholesteric LCDs appear bright in bright light just like paper. The pixels can be switched from conic to planar state or back by application of about 20-30V. Since it does not use polarizers and color filters, wide viewing angles and high brightness and contrast are obtained that is claimed to be comparable with newsprint. The display cell acts as a collection of tiny mirrors, each reflecting about 50% of the incident light. The resulting total reflection approaches 40% of the incident light. While it is not as good as paper which reflects at least 80%, compared to other reflective displays, the Ch-LCD does reflects more light than other systems. Its contrast ratio (normally 20 to 1) gets even better when taken out into the sunlight due to its reflective nature. This display is also claimed to show videos as it can be switched within 30 milliseconds. Structural rigidity and manufacturing complexity of LCD systems, however, may be considered as the major problems towards widespread implementation of such an electronic paper. For example Ch-LCD, though only 1.5 mm thick, thus it still requires a rigid plastic surface implying that it cannot be flexible.

### SUMMARY OF THE INVENTION

What are needed, therefore, are materials, methods and systems for providing displays that are reflective, flexible and adaptable at low voltages and using minimum power. Also needed are materials and methods for creating electronic devices that are made from resources that are reusable, abundant, light-weight, recyclable and that do not impact the environment. The present invention includes a reversible color changing organic fibrous surface that is, thin and flexible. Furthermore, the paper substrate maintains its reflectivity while also providing a substrate for a variable intensity dye that is homogenous per pixel.

Generally, the present invention is a device, method and system for displaying information that includes a fibrous organic substrate; and a variable reflectivity dye disposed in the fibrous substrate, wherein the reflectivity of the dye is modulated in situ. The display device uses a dye selected from an electrochromic, a thermochromic, a magnetochromic, an ionochromic, a light sensitive, a fluorescent, a fluorescent effect energy transfer dye or combinations thereof. When using these types of dyes, an external stimulus will generally applied only once and for a brief period of time, e.g., just enough to change from translucent to opaque or vice-versa, to provide homogenous pixel intensity. Using these types of dyes there is no on-going power requirement to maintain the image as the change only occurs in the presence of the reverse potential. A variety of devices may be made using the present invention, e.g., integrated circuits, capacitors, transistors, capacitance coupled devices, transformers, batteries and the like may be made using the combination of electrically conductive and non-conductive or insulating cellulose-based materials. The displays may be made using a method that includes the steps of generating a cellulose substrate, e.g., one or more cellulose microfibrils or aggregates of microfibrils called “ribbons” and depositing thereon one or more dyes, e.g., a variable intensity dye. As described herein below, by using a variable intensity dye the intensity of these the dye may be controlled, that is to change its intensity, e.g., turn on and off, flutter, gray-scale and the like.

The fibrous organic substrate may be a microorganism-produced cellulose, e.g., a member of the genus Acetobacter (now referred to as Gluconoacetobacter); a cellulose derivative such as carboxymethylcellulose, methylcellulose, hydroxyethylcellulose, hydroxypropylcellulose, hydroxypropylmethylcellulose and derivatives or combinations thereof, e.g., layered or stacked membrane(s). In certain embodiment the substrate is optically transparent, optically opaque, optically translucent, may change its opacity characteristics, e.g., in the presence of water, solvents or combinations thereof, permanently, reversibly or temporarily. The substrate may be microfibrillar cellulose that is wet, partially wet, dry, anhydrous, hydrated, coated or uncoated at a submicron thickness and may even be at least partially electrically conductive. Examples of electrically conductive regions or portions include, e.g., individually addressable wordlines and/or bitlines, vias, interconnects, and the like, that may terminate in one or more pads that permit electrical interconnects. These pads or interconnects may be further connected using conductive forms of the organic substrate (e.g., dopes) or may even be wire bonded. When used in the form of a display that includes embedded or adjacent integrated circuits, e.g., semiconductor integrated circuits, the addressable integrated circuit forms an array.

The display device may be used for visual communication, e.g., as a bulletin board, a billboard, a canvas, a newspaper, a book, a whiteboard and the like. One advantage of the display device of the present invention is that, e.g., the cellulose substrate, is flexible and may include interconnects that permit electrical connectivity despite bending or even creasing the paper. Depending on any additional coatings or processing, the display system of the present invention may be full, partially or non-biodegradable. For disposable uses, the display system may be completely recyclable as cellulose. When doped, e.g., using carbon nanotubes, sheet, pegs, scrolls, balls, cones and the like these may also be recycled during the recycling process, e.g., using magnetic, chemical, ionic and electrical or other separation techniques compatible with recycling.

The display device of the present invention may be controlled using, e.g., a computer or control logic that controls the location and extent of dye reflectivity. Dyes for use with the present invention include permanent, semi-permanent or variable intensity dyes. Examples of variable intensity dyes include, e.g., dialkyl derivatives of 4,4′-bipyridinium salts, WO₃, MoO₃, Prussian blue (PB, ironIII-hexacyanoferrate II), tetrathiafulvalene (TTF), V₂O₅, Nb₂O₅, TiO₂, IrO₂, NiOₓ, CO₂O₃ or combinations thereof. The display device may include one or more positionally distinguishable variable reflectivity dye regions (or pixels) on the substrate to provide the complete range of resolution, from low resolution (10-80 dots per inch) to high resolution (300 to 10,000 dots per inch) to high definition resolution, dots less than 10 microns. These pixels may be positionally distinguishable as regions per cm² or inch when attached to the solid substrate and may even include at least 3 different colors, e.g., primary colors or combinations thereof.

Yet another embodiment of the present invention is a system for displaying information that includes a fibrous organic substrate having a substrate display surface and an array comprising one or more positionally distinguishable and modulatable variable reflectivity dye regions. The system may further include a control logic constructed and arranged to modulate the intensity of the dye to the one or more regions. The control logic may also include a power source, e.g., at least one solar cell, one battery, one flexible battery or combinations thereof. The control circuitry for the display system may be embedded, adjacent and even detachable from the substrate. For example, the control circuitry may be manufactured independent of the substrate and the dye regions, or may be manufactured in conjunction with or within the substrate. In another embodiment, the intensity of the dye may be modulated as the dye-substrate is scanned past, developed or even printed by a control circuitry that is independent of the substrate. For example, the dye-substrate may be passed by a line or array of dye-changing elements (e.g., a charge-emitting line or array) at a constant speed and portions of the dye in the substrate are selectively varied to generate portions of contract (positive-negative or negative-positive) using the dye on the surface of the substrate. In certain embodiment, the substrate may be two or more layers and the control circuitry is at least partially interposed between two of the layers. The circuitry may even be voice or sensor activated or controlled by providing a speaker so constructed and arranged to receive speaker or sensor information to and from the control circuitry. The sensor may perceive light, motion, magnetic fields, electric changes (voltage, current), and temperature, sound or pressure changes. These sensors may be input selection regions so constructed and arranged to provide selection information to the control circuitry wherein the control circuitry is so constructed and arranged to receive and respond to the input selection, e.g., at least one selection button.

In one embodiment, the present invention includes a system for changing the display information on a multi-ribbon microbial cellulose substrate that has been embedded with one or more electrochromic dyes, the system with an electric field generator in communication with a control logic and a mechanism for progressively moving the electric field generator in relation to the substrate, wherein one or more electric fields that emanate from the electric field generator change the optical absorption characteristics of the electrochromic dye. One or more of the electric fields may be formed as emitters embedded in or about the substrate. The substrate further may also include one or more passivation layers disposed on a display surface of the substrate to protect the device against the environmental, e.g., dust, humidity, heat, oxygen and/or other gases, water, electrical discharges, certain wavelengths of light, mechanical contact, e.g., scratching or other impacts, etc. The substrate may also be in communication with one or more transceivers that are in or about the substrate and may also be in communication with the control logic. The system may also include an external or internal power source connected to, in or about the substrate connected to the control logic, e.g., a battery, an external electrical connection, a solar array and the like, e.g., the power source may be a paper battery connected to the control logic and embedded in the substrate. In one specific example, the electric field generator may be in the form of a printer head and the mechanism for moving the electric field in relation to the substrate is a printer, e.g., a handheld device, a stationary device, a continuous printing device and the like. In another specific example, the substrate may be an electrically conductive cellulose and the control logic is formed in the substrate.

The display system may also include a communication interface for communicating with the control circuitry, e.g., a network interface such as a wire, an optical or other fiber, IR or RF connector, antenna, receiver, transceiver, transmitter and combinations thereof. The display system may be flexible and even planar. Examples of semiconductor circuits for use with the present invention may be control logic, such as a capacitance coupled-device that modulates the reflectivity of the dye. Another example is a display system that includes a fibrous organic substrate having a substrate display surface, an array comprising one or more positionally distinguishable variable reflectivity dye regions and control logic so constructed and arranged to modulate the intensity of the dye to the one or more regions. As with previous embodiments, the dye may be an electrochromic, a thermochromic, a magnetochromic, an ionochromic, a light sensitive, a fluorescent, a fluorescent effect energy transfer dye or combinations thereof and the fibrous organic substrate may be, e.g., crystalline native cellulose I, regenerated cellulose II, nematic ordered cellulose, a glucan chain association, chitin, curdlan, β-1,3glucan, chitosan, cellulose acetate, polysaccharide, glycoprotein and combinations thereof.

Yet another invention is a device that includes an insulative cellulose substrate; and one or more regions disposed on the insulative cellulose substrate that are electrically conductive the regions being electrically isolated from each other by substantial electrical impedance through the insulative substrate and between the conductive regions, wherein the regions establish independent electronically functional structures for the performance of resistive, reactive and active signal modification functions. The present invention also include a method of making a cellulose-based integrated circuit that includes the steps of forming a cellulose substrate; implanting a partially conductive field in the cellulose substrate; forming an electrically insulative layer on the conductive field; and forming a conductive layer on the electrically insulative layer to form a gate about the field.

One example of the present invention is a capacitor made in cellulose that includes a first and a second plate, wherein at least one of the plates comprises electrically conductive cellulose; and a non-conductive cellulose layer disposed between the first and second plates. Another embodiment is a paper battery in which a first and a second plate and a conductive cellulose layer disposed between the first and second plates, whereby an electric potential is stored between the first and plates. Yet another embodiment of the invention is an isolated and purified synthetic cellulose layer that is less than or about 1 micron in thickness. The cellulose may also include an ionic salt coating, e.g., an ionic salt coating of LiCl. The cellulose may be microfibrillar cellulose substrate that is wet, partially wet, dry, anhydrous, hydrated, coated or uncoated at a submicron thickness; or even, a crystalline native cellulose I, regenerated cellulose II, nematic ordered cellulose, a glucan chain association, chitin, curdlan, β-1,3glucan, chitosan, cellulose acetate, polysaccharide, glycoprotein and combinations thereof. In some embodiments, the cellulose is conductive, e.g., having a resistance ranging from 1 k-ohms to 30 megaohms.

In yet another embodiment, the isolated and purified synthetic conductive cellulose is coated with a conductive ion. Alternatively, the invention includes a rewritable display system that includes a fibrous organic substrate (e.g., a cellulose substrate) having a substrate display surface, a stylus that is positioned at or about a switchable dye, an array comprising one or more positionally distinguishable variable switchable dye regions and a control logic so constructed and arranged to modulate the intensity of the dye to the one or more regions. The dye may be an electrochromic, a thermochromic, a magnetochromic, an ionochromic, a light sensitive, a fluorescent, a fluorescent effect energy transfer dye or combinations thereof. The underlying substrate of the display system may be impregnated with PEG-KCl, LiCl-methanol or Carbon-nanotubes. The display may be controlled by input from a stylus that changes one or more dyes thereby producing color, e.g., colors that are formed by combinations of two or more of the following dyes: WO₃, NiOₓH_{y}, V₂O₅, iron hexacyanoferrate, methyl viologen, polyaniline, polypyrrole, PEDOT, lutetium bis-phthalocyanine, salts and mixtures thereof. The switchable dye may be in one or more pixels may also include one or more pixels that are LiCl-methanol-based. The one or more pixels may be connected electrically using carbon nanotubes, e.g., with one or more pixels are electrically connected using carbon nanotubes in a poly-ethylene glycol (PEG) base.

Yet another embodiment is a display system that includes a fibrous substrate having a first and a second portion, wherein the first portion displays information and the second portion comprises a control system; and an array comprising one or more positionally distinguishable and modulatable variable reflectivity dye regions, wherein the intensity of the dye is under the control of the control system. In one specific embodiment, the first and second portions are “in-plane” that is, they reside generally in the same three dimensional plane, however, the present invention also includes adjacent planes, planes that are side by side, on top of each other, and combinations thereof. For example, the first portion may be a display surface and the second portion is opposite the display surface and/or the first and second portions are substantially adjacent. The dye intensity in the first portion may be rewritable. Examples of the use of this embodiment include a rewritable learning tool for children, a map, a wallpaper, a street sign, a billboard, a newspaper, a book, a computer screen, a glass, a wall, a sheet or combinations thereof. An in-plane switching device may also be a biodegradable multi-ribbon cellulose substrate having a first and a second surface onto which one or more variable intensity dye regions have been bound and at least one conductive pattern is deposited on each of the first and second surfaces, wherein the light absorption characteristics of the dye are modified when the device is exposed to an electric field created between the conductive patterns on the first and second surfaces. In one specific example, the conductive pattern is an array of conductive patterns, each pattern addressable separately by a control logic, e.g., a computer control logic.

At the molecular level and for use in high definition screens, e.g., high definition paper the molecular display system may be built around a nano component (e.g., a single polymer chain of cellulose, or crystalline or non-crystalline aggregates of cellulose polymer chains either equivalent to cellulose I or cellulose II), an electrochromic dye molecule disposed on or about the cellulose polymer chain or crystalline unit; and a nanoscale control system (e.g., a system based on carbon nanotubes, wires, sheets and the like) that controls the intensity of the electrochromic dye. Another molecular embodiment is an in-plane display system that includes a fibrous substrate comprising an in-plane first and a second portions, wherein the first portion displays information and the second portion having a control system; and an array with one or more positionally distinguishable and modulatable variable reflectivity dye regions, wherein the intensity of the dye is under the control of the control system using radio frequency. When under the control of a radio frequency, the dye intensity may be controlled by a transmitter, e.g., the megahertz to gigahertz range. In one embodiment, the radio frequency is in the reverse direction from a current that creates a radio frequency field that modulates the variable reflectivity dye region. The display system may be further coated with a perfluorooctane sulfonate layer.

The cellulose and conductive cellulose of the present invention may be formed into an integrated circuit that includes one or more inductive electrical components integrated disposed on a cellulose substrate and a variable reflectivity dye disposed at or about the inductive electrical components, wherein activation of the inductive electrical component causes the variable reflectivity dye to change intensity. The inductive electrical components may form a dense array, e.g., 10, 100, 1000 or even 10,000 dots per inch. The inductive electrical components may include one or more passive component device(s), a dense array that include individually controllable passive component devices, one or more individually controllable passive component device and even inductive electrical components include a passive component device that has a spiral inductor.

In yet another embodiment, the present invention includes a method of making an integrated circuit by forming at least one inductive electrical component integrated on or about a cellulose substrate and a variable intensity dye. For example, the inductive electrical component may be a radio frequency (RF) passive component. The present invention also includes one or more display system(s) that include a cellulose substrate, one or more RF induced integrated circuits disposed at the cellulose substrate; and one or more variable intensity dyes or dye portions, wherein dye intensity is under the control of the RF induced integrated circuits. The display may also include an adhesive disposed on the cellulose substrate and the RF induced integrated circuits may form an array. The RF induced integrated features are disposed in an array having greater that 10, 80, 100, 300, 500, 1,000 features per linear inch. Another embodiment of the present invention is a display system that requires no internal power source having a cellulose substrate, one or more RF induced integrated circuits disposed at the cellulose substrate; and one or more variable intensity dyes, wherein dye intensity is controlled by the RF induced integrated circuits and power is provided to the RF induced integrated circuit from a remote source.

The display system of the present invention may also by a high definition paper, which uses regular dyes that are disposed at the molecular level on one or more and/or polymer chains, or crystalline or non crystalline aggregates of polymer chains of cellulose. The high definition paper of the present invention may be used in a display that provides a high storage density, high contrast cellulose substrate, which may be visualized using analog or digital enhancement, e.g., a microscope or even a stereomicroscope. Examples of the cellulose substrates that could be used to manufacture any form of electronic paper include native cellulose from any source such trees, cotton, any vascular plant, any non-vascular plant such as algae, mosses, liverworts, any animal that synthesizes cellulose, such as tunicates or sea squirts, any prokaryotic organism, such as cyanobacteria, purple bacteria, archaebacteria, any derivatized form of cellulose such as cellulose nitrate, acetate, carboxymethylcellulose, native crystalline cellulose, cellulose I, cellulose I alpha allomorph, cellulose I beta allomorph, processed crystalline celluloses, such as cellulose II non crystalline cellulose, such as nematic ordered cellulose (NOC) and combinations thereof.

Yet another embodiment of the present invention is a method of making a high resolution quantum dot display that includes the steps of forming a cellulose substrate with one or more semiconductor template peptides to form a cellulose-peptide complex; and growing one or more semiconductor quantum dots at the peptides. The peptides may be complexed with the cellulose substrate by growing the cellulose substrate in the presence of the peptides or complexed with the cellulose substrate by depositing the peptides on the cellulose substrate. The semiconductor template peptide may be selected by binding to a predetermined face specificity semiconductor material. In another embodiment, the semiconductor template peptide directs the formation of a predetermined face specificity semiconductor material upon exposure to a first ion to create a semiconductor material precursor and a second ion to the semiconductor material precursor, wherein the polymeric organic material directs formation of the predetermined face specificity semiconductor material. The semiconductor template peptide may be amino acid polymers of between about 7 and 20 amino acids. The semiconductor material formed at the peptide may be polycrystalline, single crystalline or amorphous and will generally be selected from a Group II-IV semiconductor material. Examples of semiconductor material include zinc sulfide and the solutions are zinc chloride, sodium sulfide and solutions of sodium sulfide, cadmium sulfide and the solutions are cadmium chloride and sodium sulfide.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a graph that demonstrates the resistance (measured along 1 cm×1 cm substrate) v/s Time (days) of the conductive cellulose of the present invention;

FIGS. 2A and 2B show a coated fibril of bacterial cellulose taken in polarization mode in a Zeiss Light Microscope using 16× objective, FIG. 2B is the same fibril rotated 90° to detect orientation;

FIG. 3A is a picture of conductive cellulose taken in TEM at 3000× magnification, (scale bar is 0.5 μm), and FIG. 3B is a TEM image of same structure at 27500× (scale bar is 0.2 μm);

FIG. 4A is a TEM Image of conductive cellulose at 12400×, FIG. 4B is an image taken at 27500× magnification in TEM at 0° tilt, and 4C is an image taken with a 35° tilt at 27500× magnification;

FIG. 5 is a graph that shows the resistance (measured along 1 cm×1 cm substrate) v/s Concentration of LiCl in methanol (wt %/vol);

FIG. 6A is a picture of conductive cellulose taken at 16× polarization optics in light microscope, and FIG. 6B is a picture taken at the same setting but rotated 90° to indicate orientation;

FIG. 7 is a cross section is an electronic paper device made with the materials and methods of the present invention;

FIGS. 8A and 8B demonstrate that a particular image may be displayed at certain potentials across pixels;

FIG. 9 shows basic resistive and capacitive elements constituting one image pixel;

FIG. 10 is an illustration of a battery device using the conductive cellulose of the present invention that can be used to provide a flexible battery and to power the devices disclosed herein;

FIG. 11A is a cross-sectional view of a DRAM cell using the present invention;

FIG. 11B is a top view of a pair of DRAM cells using standard 8f2 geometry and the present invention;

FIG. 11C is a top view of a group of standard 8f2 DRAM cells using the conductive and non-conductive cellulose of the present invention;

FIG. 12 is a block diagram of a sensor array according to the present invention;

FIG. 13 illustrates the physical structure of the individual sensor cells and their electrical operation according to the present invention; and

FIGS. 14A through 14E demonstrate the results obtained with a conversion cycle of methyl viologen on a conductive cellulose substrate at 2.5 volts to and from a clear to an opaque non-reflective dye on a clear reflective bacterial cellulose substrate;

FIGS. 15 A through 15D are TEM micrograph showing (15A) Dispersion of nanotubes in methanol (33,000×); (15B) Resolution of a single nanotube (160,000×); (15C) a dispersion of nanotubes along the fibril (DF: 2,100×); and (15D) a dispersion of the nanotubes along the fibrillar structure of bacterial cellulose (2,100×) (note: magnification and dimensions are same in images 15C and 15D);

FIGS. 16A and 16B show that the e-paper system has a high contrast and bistability;

FIG. 17 is a micrograph showing the dendritic deposition of polyethylene glycol on the bacterial cellulose surface (Polarization 800×);

FIG. 18 is an image (4×) of color change in the KCl—PEG system (in-plane device);

FIG. 19 illustrates a rewritable stylus-based system in accordance with the present invention;

FIGS. 20A to 20D demonstrates that the writing and erasing of the electronic paper of the present invention;

FIG. 21 is a single pixel-level color changes in the display device;

FIG. 22 shows the basic electronics for an in-plane switch for use with the present invention for displaying alphanumeric characters in the in-plane display device;

FIG. 23 shows two examples of dyes and chemical modifications for use with the present invention;

FIG. 24 shows the design for an in-plane switching mechanisms for use with the present invention;

FIG. 25 is a cross sectional view of the in-place switching using lines printed on a substrate in accordance with the present invention; and

FIG. 26 shows a design for a microcontroller that controls a display as shown.

### DETAILED DESCRIPTION OF THE INVENTION

While the making and using of various embodiments of the present invention are discussed in detail below, it should be appreciated that the present invention provides many applicable inventive concepts that may be embodied in a wide variety of specific contexts. The specific embodiments discussed herein are merely illustrative of specific ways to make and use the invention and are not to delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims. As used herein, all technical and scientific terms have the same meaning as understood commonly by one of ordinary skill in the art to which this invention belongs, unless defined otherwise. Methods and materials similar or equivalent to those described herein may be used in the practice or testing of the present invention.

As used herein the term, “cellulose” and “cellulose substrate” include not only bacterial cellulose, but also native cellulose from any source such trees, cotton, any vascular plant (angiosperms and gymnosperms), any non-vascular plant such as algae, mosses, liverworts, any animal that synthesizes cellulose (such as tunicates or sea squirts), any prokaryotic organism (such as cyanobacteria, purple bacteria, archaebacteria, etc. A complete list and classification is available from the present inventors at: http://128.83.195.51/cen/library/tree/cel.htm. As the inventors' list shows the cellulose may be from an organism that has one or more cellulose synthase genes present. Furthermore, cellulose also includes any derivatized form of cellulose such as cellulose nitrate, acetate, carboxymethylcellulose, etc. Cellulose also includes any form of native crystalline cellulose, which includes not only the native crystalline form (called cellulose I, in its alpha and beta sub allomorphs, all ratios, whether pure alpha or pure beta). Cellulose for use with the present invention also includes all processed crystalline celluloses, which deviates from the native form of cellulose I, such as cellulose II (which is are precipitated crystalline allomorph that is thermodynamically more stable than cellulose I). Cellulose includes all variations of molecular weights ranging from the lowest (oligosaccharides, 2k-50 glucan chains linked in the B-1,4 linkage), low molecular weight celluloses with a degree of polymerization (dp), which is the number of glucose molecules in the chain, of 50 to several hundred, on up to the highest dp celluloses known (e.g., 15,000 from some Acetobacter strains, to 25,000 from some algae). The present invention may also use all variations of non crystalline cellulose, including but not limited to, nematic ordered cellulose (NOC).

As used herein the term “display device” is used to define a surface that is visible to the human eye, aided or unaided, to perceive a contrast between one or more adjacent portions of the surface. In conjunction with the present invention, a display device may be a sheet of paper, a newspaper, a billboard, a screen, a computer screen, a canvas, a partition, wallpaper, a storage device, a high definition paper, a window, a heads-up display, and the like. The surface may be see-through, partially see-through or opaque. In certain embodiments, the display device takes advantage of the contrast capacity of paper or paper-like substrates (as compared to a film, plastic, microfilm, etc.) to permit the a viewer or viewing device (analog or digital) to detect a difference between adjacent portions, e.g., pixels with low resolution or high resolution.

As used herein, the term “viewing” refers to the ability of a human, or a human in conjunction with an apparatus sensitive to the electromagnetic energy of interest. If the electromagnetic energy of interest lies in the visible spectrum, then viewing refers generally to a human. If the electromagnetic energy of interest lies outside of the visible spectrum, then viewer refers generally to an apparatus sensitive to the electromagnetic energy and capable of resolving the aspects of interest into a human perceivable form.

As used herein, the term “fibrous organic substrate” is used to describe a substrate that may be used with the display device that is fibrous and organic, that is, from a natural source. The fibrous organic substrate may be, e.g., cellulose such as a microorganism-produced cellulose. One example of microorganisms that produce a fibrous organic substrate include members of the genus Acetobacter (now referred to as Gluconoacetobacter) or bacteria, microorganisms or organisms or tissues that have been transformed (permanently or transiently) with one or more genes capable or required for manufacturing cellulose and strains or sub-strains related to or derived therefrom. The fibrous organic substrate may be a cellulose derivative, such as carboxymethylcellulose, methylcellulose, hydroxyethylcellulose, hydroxypropylcellulose and hydroxypropylmethylcellulose or combinations thereof. The fibrous organic substrate may be a microfibrillar cellulose that is wet, partially wet, dry, anhydrous, hydrated, coated or uncoated at a submicron thickness.

As used herein, the term “variable reflectivity dye” is used to describe a dye with intensity that may be changed based on changes in, e.g., charge, chemical composition, ionic state, and the like. The dye may be one or more molecules and may change its intensity anywhere in the light spectrum, that is, in certain embodiments the dye may fall within the visible range. One type of dye for use with the present invention is a variable intensity dye that changes and maintains its intensity (opaque, partially opaque, transparent or translucent) upon placing a charge on the dye. Another type of variable intensity dye for use with the invention is a dye that changes and maintains the change in intensity upon placing a charge on it, that is, the dye maintains the change even is the charge is withdrawn from the dye. Examples of variable intensity dyes for use with the present invention includes an electrochromic, a thermochromic, a magnetochromic, an ionochromic, a light sensitive, a fluorescent, a fluorescent effect energy transfer dye or combinations thereof. Examples of dyes for use in the variable intensity embodiments include dialkyl derivatives of 4,4′-bipyridinium salts, WO₃, MoO₃, Prussian blue (PB, ironIII-hexacyanoferrate II), tetrathiafulvalene (TTF), V₂O₅, Nb₂O₅, TiO₂, IrO₂, NiOₓ, CO₂O₃ or combinations thereof. For permanent storage or high definition display embodiments, the dye may be any of those known in the art of printing. For each variable reflectivity dye, a matching electromagnetic or other source may be provided alone or in combination to modify the reflectivity of the specific dye. For example, various dyes may be spotted into one location such that each, e.g., each reflecting a different primary color, are modified selectively by a separate electromagnetic source, e.g., one may be an electric field, another may be light and a third may be a magnetic field. As such, color displays may be made that may be individually addressable at the same time with one or more electromagnetic sources at the same or separate times. Another specific example may be changing a display from a remote location, such a billboard from the ground, by exposing the one or more dyes to a field from the ground, e.g., using a digital light processor that transmits a dye reflectivity-changing light to a display on, e.g., a wall or billboard remotely. The display device may include one or more positionally distinguishable variable reflectivity dye regions attached to the substrate of at least about 100, 300, 1000, 3000, 10,000, 30,000 or 100,000 positionally distinguishable regions per cm² attached to the solid substrate. The attached dyes may include at least 3 different colors, e.g., primary colors or combinations thereof. The display device may also include a semiconductor substrate.

As used herein, a “microfabricated substrate” or “semiconductor substrate” are used herein to describe a microfabricated solid surface to which molecules attach through either covalent or non-covalent bonds and includes, e.g., silicon, Langmuir-Bodgett films, functionalized glass, germanium, ceramic, a semiconductor material, PTFE, carbon, polycarbonate, mica, mylar, plastic, quartz, polystyrene, gallium arsenide, gold, silver, metal, metal alloy, fabric, and combinations thereof capable of having functional groups such as amino, carboxyl, thiol or hydroxyl incorporated on its surface. Similarly, the semiconductor substrate may be incorporated into the cellulose substrate as taught herein. The semiconductor substrate surface is not fixed, constrained or even uniform. The semiconductor substrate may be porous, planar or nonplanar. The semiconductor substrate may include a contacting surface that may be used as the interface with the cellulose substrate itself or one or more additional layers (e.g., one or more cellulose substrates, one or more biologic materials, coating, semiconductor substrate with a contacting surface) made of organic or inorganic molecules and to which organic or inorganic molecules may contact. Semiconductor substrates may be supported to improve their mechanical strength or surface to volume ratio.

As used herein, the terms “inorganic molecule” or “inorganic compound” are used to refer to compounds such as, e.g., indium tin oxide, doping agents, metals, minerals, radioisotope, salt, and combinations, thereof. Metals may include Ba, Sr, Ti, Bi, Ta, Zr, Fe, Ni, Mn, Pb, La, Li, Na, K, Rb, Cs, Fr, Be, Mg, Ca, Nb, Tl, Hg, Cu, Co, Rh, Sc, Y or combinations thereof. Inorganic compounds may include, e.g., high dielectric constant materials (insulators) such as barium strontium titanate, barium zirconate titanate, lead zirconate titanate, lead lanthanum titanate, strontium titanate, barium titanate, barium magnesium fluoride, bismuth titanate, strontium bismuth tantalite, and strontium bismuth tantalite niobate, variations or combinations thereof, as will be known to those of ordinary skill in the art.

As used herein, the term “emitter” is used to describe any circuit or device that may be used to create an electromagnetic field or emission, e.g., an electric field, magnetic field, light or other particles or waves with sufficient energy to modify the light absorption characteristics of a dye. Other emitters may emit heat, cold, radio frequency waves, etc., that match the type of variable reflectivity dye that is disposed in the substrate. As such, an emitter for use with the present invention may include one or more combinations of emitters in a single or in separate emitters.

The present invention is described in conjunction with display devices; however, the present invention may be used with any other type of electronic device as discussed herein below. Using ionic solution deposition, a new kind of cellulose complex has been synthesized. As opposed to the native form of cellulose found in various plant cell walls used mainly in form of paper, wood among others is inherently non-conductive. The major applications of cellulose, e.g., paper, wood, etc., are mainly due to its good mechanical properties (strength and toughness), optical properties (color and good reflectivity) and abundance. While cellulose is an excellent insulator in capacitors, however, cellulose has yet to find use in conductive electronics due to its poor electrical properties. In conjunction with the application and need for a conducting substrate for electrochromic dyes, the inventors have developed materials and methods to make cellulose conductive in useful ranges. The conductivity was maintained over time at room temperature. The conductivity of pure cellulose is negligible; however, using the present invention and variations in the conductors used, a good conductivity may be maintained at different temperatures and under different conditions. However, as disclosed herein cellulose may be converted to provide conductivity when combined with carbon nanotube conductors.

Cellulose may be produced by microorganisms of the Acetobacter, Rhizobium, Alcaligenes, Agrobacterium, and Pseudomonas type (see, for example Brown, Jr., et al., J. Applied Polymer Science: Polymer Symposium (1983) V. 37 pp 33-78, relevant portions incorporated herein by reference). The growth of cellulose-producing microorganisms with production of cellulose may occur when the microorganisms are aerobically cultivated in an appropriate nutrient medium. Appropriate nutrient media of the present invention generally include standard nutrient medium such as GYC which contains (g/liter of distilled water): yeast extract, 10.0; D-glucose, 50.0; CaCO₃, 30.0 and agar, 25.0. Various alternatives such as replacements for glucose or yeast extract, and omissions of agar or CaCO₃ are usable and well-known to those skilled in the art (Bergey's Manual of Systematic Biology, Vol. 1 pp 268-276, Krieg, ed. Williams and Wilkins, Baltimore/London (1984)). One useful nutrient medium used directly or with modifications described herein was that first described by Schramm and Hestrin (Hestrin, et al., Biochem. J. Vol. 58 pp 345-352 (1954). Standard Schramm Hestrin (SH) medium contains (g/L): D-glucose, 20; peptone, 5; yeast extract, 5; dibasic sodium phosphate, 2.7, and citric acid monohydrate, 1.15 (pH adjusted to between about 3.5 and 5.5 with HCl). When SH is used without glucose (SH-gluc), this indicates the above SH composition, but without the 10 g glucose/liter addition.

The cellulose produced by Acetobacter xylinum (formerly known as Acetobacter aceti subsp. xylinum and reclassified by the 1984 Bergy's Manual cited above as a subspecies of Acetobacter pasteurianus and Acetobacter hansenii) has been widely studied. In the present application the primarily studied cellulose-producing microorganism is termed “Acetobacter xylinum,” also known as Gluconacetobacter xylinus subspecies xylinus or equivalents thereof. It is understood that these several names may be used to indicate the same organism as is the cellulose derived from related bacteria or bacteria that include the genes that are necessary to produce plant or microbial-derived cellulose. In one example, Acetobacter strain NQ-5 (ATCC 53582), deposited with the American Type Culture Collection (ATCC) may be particularly useful. Cellulose for use with the present invention may be made in accordance to the general teachings of U.S. Pat. No. 4,942,128, relevant portions incorporated herein by reference. Yet another strain that may be particularly useful for the present invention is Acetobacter strain AY-201 (23769) also available from ATCC, although this invention is not limited to any particular strain of any cellulose producing bacterium or prokaryotic organism.

Fibrillar alterations of microbially-produced cellulose have been previously shown to occur, for example, by ultrastructural studies using techniques such as electron microscopy (Haigler, et al., J. Cell Biology, Vol. 94 pp 64-69 (1982) and Ben-Hayim et al. J. Cell Biology, Vol. 25 pp 191-207 (1965)). Microbial production of a cellulose leads to greatly improved and/or unique macroscopic properties such as resiliency, elasticity, tensile strength, degree of water absorptivity or retention of absorptive capacity after repeated wettings. Cellulose assembled by a static aerobic culture of Acetobacter xylinum may be contained in a hydrophilic membrane known as a pellicle. This cellulose is quite strong when wet, but brittle when dried. One of the major obstacles in using the natural absorbency of this native bacterial cellulose has been its inability to effectively retain absorbency through cycles of wetting and drying. To improve the physical properties of the cellulose, a cellulose derivative such as carboxymethylcellulose (CMC) may be added to the culture medium during microbial synthesis of cellulose. Inclusion of CMC in the culture medium alters the produced cellulose to result in a product that retains most of its native absorbency through cycles of wetting and drying. The physical properties of microbial cellulose product by cellulose derivatives or related substances expand the material uses of cellulose. Such a form of cellulose has many potential applications in the upcoming technologies relating to electronic paper (using electrochromic dyes directly on the conducting substrate), Li batteries (as electrolytes for ion transport) and fuel cells (as proton exchange membranes). Electronic paper, paper-thin batteries, and fuel cells are already identified among the most promising emerging technologies of the near future. Several groups are already working on these lines with different approaches using thin film plastics among other materials.

Examples of cellulose-producing bacterial strains for use with the present invention include those taught by one of the present inventors in: U.S. Pat. No. 4,954,439, entitled, “Multiribbon microbial cellulose,” relevant portions incorporated herein by reference. As used with the present invention, a biologically pure culture of a cellulose-producing microorganism is capable, during fermentation in an aqueous nutrient medium with one or more assimilable sources of carbon, nitrogen and inorganic substances, of reversal of direction of cellulose ribbon extrusion. This reversal of direction of cellulose ribbon extrusion results on the cellulose-producing microorganism shuttling, at least periodically, first in one direction and then in the other direction along a length of an earlier-deposited cellulose ribbon to add another cellulose ribbon thereto and produce a cellulose ribbon-bundle having a width of at least two cellulose ribbons. It has been found that this particular structure is well-suited for the creating and manufacture of the displays of the present invention. The cellulose-producing microorganism of the present invention may be of the genus Acetobacter, Agrobacterium, Rhizobium, Pseudomonas or Alcaligenes, preferably of the genus Acetobacter and more preferably of the species Acetobacter xylinum or Acetobacter pasteurianus. Certain bacteria include, e.g., Acetobacter xylinum strains are strain NQ5, H1A; H1B; H1C; H2A; H2B; H₅C; H5D; H6C; H8C; H8G; H14B; H15A; and H15B. Acetobacter xylinum strain NQ5 has identifying characteristics of ATCC 53582 on deposit with the American Type Culture Collection, Rockville, Md.

The cellulose ribbon-bundles produced by the cellulose-producing microorganism of the present invention may be characterized as including anti-parallel cellulose ribbons with β-1,4 linkages proceeding in a first direction alternating with cellulose ribbons having β-1,4 linkages proceeding in an opposite direction. The alternating structure results from reversals in the direction of cellulose ribbon extrusion from a microorganism traveling along a previously deposited cellulose ribbon and depositing a new cellulose ribbon, which becomes hydrogen-bonded to the adjacent, earlier-deposited cellulose ribbon. The cellulose may be produced by a cellulose-producing microorganism aerobically cultivated in an aqueous nutrient medium having a pH between about 3 and about 7 and at a temperature between about 20° C. and about 40° C.

The anti-parallel cellulose ribbons with β-1,4 linkages are made in a nutrient medium with assimilable sources of carbon and inorganic salts (and nitrogen when growth is desired). The medium is generally incubated after an inoculation with a biologically pure culture of a cellulose-producing microorganism, capable, during incubation in said nutrient medium, of repeated reversals of direction of cellulose ribbon extrusion. Such directional reversals of extrusion as described above, result in said cellulose-producing microorganism shuttling, at least periodically, first in one direction and then in the other direction along a length of one or more earlier extruded cellulose ribbons to add another cellulose ribbon thereto. A cellulose ribbon-bundle is produced that is stronger than that produced by non-shuttling microorganisms. The ribbon-bundles have a width of at least two, three or more, cellulose ribbons. The cellulose is collected for use and further processed to produce the displays of the present invention. One advantage of the displays of the present invention is that, under the proper circumstances, the entire display is biodegradable and/or recyclable. For example, the cellulose may be degraded using enzymatic or chemical methods to retrieve the cellulose subunits followed by recapture of the underlying circuitry that forms the backplane electronics. When using electrically conductive cellulose the entire display may be recycled.

A typical suitable nutrient medium for culture of cellulose-producing microorganisms is, e.g., Schramm & Hestrin medium (Schramm et al., J. General Microbiology, Vol. 11, pp. 123-129, 1954) with about 20 g/l glucose; 5 μl peptone; 5 g/l yeast extract; 2.7 g/l anhydrous dibasic sodium phosphate; and 1.15 g/l citric acid monohydrate. The pH of the medium is generally adjusted to between about pH 3.5 and about pH 5.5 by the addition of acid. Another suitable nutrient medium may include about 8 volume percent vinegar, 5 volume percent ethanol and 4 weight percent malt extract. Any of a wide variety of nutrient media having a pH between about 3 and about 7 are suitable for the practice of the present invention (as taught by Bergey's Manual of Systematic Bacteriology Vol. 1, (ed. N. R. Krieg, pp. 268-274, Williams and Wilkins, Baltimore, Md. 1984, relevant portions incorporated herein by reference). Such suitable nutrient media may preferably include a hexose, most preferably glucose, acetic acid and yeast extract. Yet another suitable nutrient medium, adjusted to the above described pH range, is corn steep liquor. Also, resting cells, capable of producing cellulose, require only for example glucose and phosphate buffer for such production. When microbial growth is desired, a source of assimilable nitrogen will generally be present.

These antiparallel ribbon alignments result in glucan chain interrelationships similar to cellulose II structure, however, the antiparallel ribbon alignment result in one additional inter-ribbon hydrogen bond for each pair of interacting glucosic units. This additional hydrogen bond, along with the greater numbers of ribbons in a bundle, is consistent with an apparent greater physical strength observed. While non-shuttling cellulose-producing microorganisms may sporadically produce bundles of parallel multiple cellulose ribbons, only cellulose-producing microorganisms capable, during incubation in nutrient medium, of repeated reversals of direction of cellulose ribbon extrusion characteristically and consistently produce cellulose ribbon-bundles comprising at least two or, more frequently, more than three cellulose ribbons. These latter ribbon-bundles may be further characterized by the anti-parallelism described above. The product cellulose, because of the anti-parallel inter-ribbon alignments present appears to be a polymorph of cellulose I and cellulose II.

The present invention finds particular use in the formation of integrated circuits and devices. Furthermore, it has been found that the advantages derived from the present invention are applicable to display devices. In case of electronic paper this is highly advantageous because using cellulose retains all the advantages of the actual paper (good reflectivity, flexibility, low power). The display device, methods and system disclosed herein may be applied to a wide-range of technologies. There are a number of forms and sources for cellulose. For example, microfibrillar cellulose is crystalline and belongs to the cellulose I allomorph (which has two different sub-allomorphs, cellulose Iα and cellulose Iβ). Depending on the specific uses, shape, source (bacterial, plant, synthetic, other), locations (capacitor, gate, surface, passivation), materials (all organic, on silicon, on plastic), cost, ease of use, etc., different forms of cellulose and/or combinations of the same, may be used with the present invention. For example, different forms of cellulose 1α may be better for one application but design choice and durability may cause the designer to select another form of cellulose, e.g., cellulose 10. However, even nematic ordered cellulose (see, for example, Kondo, T., Togawa, E. and R. M. Brown, Jr. 2001. “Nematic Ordered Cellulose”; A concept of glucan chain association. Biomacromolecules 2: 1324-1330) may be used alone or in combination with crystalline cellulose I (as synthesized by Acetobacter or as reprecipitated to form cellulose II (=Rayon) by synthetic post-synthesis approaches).

Conductive Microbial Cellulose. Varying thickness of bacterial cellulose sheets have been used for developing conducting cellulose. For example, the present inventors have been able to produce paper membranes that are in the order of 600 nm thick, (measured based on the interference colors generated). The nanostructure within these extremely thin paper membranes is very conducive for many useful applications. For example, using the materials and methods disclosed herein, it is now possible to conduct epitaxial deposition of conducting salts along the nanostructure of the microbial cellulose membranes.

Cellulose is the nature's most abundant polymer composed of β-1,4 glucan chains. It has been used in the textile and forestry industries. In such applications, entire cells microns in diameter are the norm for the structure of the products. On the other hand, native microbial cellulose consists of fine ribbon fibrils whose width is approximately 100 nm. The lengths of these fine fibrils can range from about 1-9 μm, and they form a dense reticulated structure (see, for example, Brown, R. M., Jr., J. H. M. Willison, and C. L. Richardson. 1976. Cellulose biosynthesis in Acetobacter xylinum: 1. Visualization of the site of synthesis and direct measurement of the in vivo process. Proc. Nat. Acad. Sci. U.S.A. 73(12):4565-4569).

Various techniques and materials may be used in conjunction with the present invention. For example, different variable reflectivity dyes may be used, alone or in combination, to fully develop the potential of electronic paper using a cellulose/paper-based substrate for different application, whether consumer, customized, disposable or even military applications. Examples of dyes are listed below.

Magnetic Particles Display. Magnetic imaging uses a display area with magnetic particles which can be oriented by external magnetic fields to form readable signs. The oriented magnetic particles retain their position when the external field is removed, thus allowing storage of the recorded information. When magnetic stimuli are compared with electrical field stimuli; it involves more complicated image-forming techniques. Magnetically reflective dyes use tiny particles, each of which is a plastic magnet that includes a ferrite powder held together by a suitable binder. A magnetic field generated by conductors nearest a desired image spot controls the orientation of the particles proximate to that spot.

Another variable reflectivity dye that may be used with the present invention is one based on magnetic particles within cellulose. A mass of elongated particles are affixed, chemically or in beads to the cellulose. When a magnetic flux with field lines perpendicular to the magnetic dye is applied, the elongate particles move into alignment with the field lines in the region over which the flux is applied. Although these magnetochromic dyes are somewhat more expensive than ordinary dye, it has the additional merit that the recorded information easily, can be erased when desired, and may be readily reused. In one example, a magnetic wand may be used on a whiteboard, bulletin board or sheets of paper on an easel that has been coated with the magnetochromic dye-cellulose substrate to cause a change in the reflectivity, be it from dark to light or vice versa. Furthermore, in this application the change in magnetic polarity may also be detected by a substrate behind the magneto-cellulose surface to provide a digital file that reflects the images draws or written for object-character recognition, storage as an electronic file or for sharing of the electronic file over an intra, inter or extranet, for example, for distance learning.

Photochromic dyes (Photo-induced stimulus). Another type of variable reflectivity dye for use with the present invention is a photochromic dye. Photochromism in its broad sense is a reversible change in the absorption system of a material induced by electromagnetic radiation. Particularly, the definition can be restricted to a reversible change in the color or darkening of a material caused by absorption of ultraviolet or visible light. Schematically, the photochromic reaction can be stated by the simple equation as follows: A [symbol] B. Substance A has an absorption spectrum in one or more regions of the ultraviolet or visible spectral range. Irradiation of A at a wavelength corresponding to one of the absorption bands results in formation of substance B, which has a visible absorption spectrum different from A. Most commonly, substance A is uncolored or only slightly colored, whereas substance B is colored or appears darker than A. The reverse reaction, B returning to A, can be driven either by thermal or photochemical energy, or both. When the reversion is photochemically driven, the process is called optical bleaching.

Photochromic systems can be separated into two broad categories, organic and inorganic. An organic-inorganic hybrid photochromic system also has been introduced. Inorganic systems are based on photochromic silver halide-containing glasses that are not possible to be developed in paper-related applications due to their rigid structure and high temperature processing requirements. Organic photochromic systems that have been studied are numerous and include the category of organic dyes. Photochromic organic dyes (optically switchable, bistable organic dyes/pigments) have been intensively studied especially as optical data storage. Organic dyes based on cyanine, naphthochinone, and benzothiopyrane and copper-phthalocyanine pigments have been described. The advantages of organic dyes are their high optical density and simple applicability to substrates (spin-coating, sublimation, vapor deposition, etc.).

An important issue in photochromic systems is fatigue. Fatigue is defined as a loss in photochromic activity as a result of the presence of side reactions. Fatigue, therefore, leads to the loss of total reversibility within the photochromic reaction. Also, only two variable characteristics have to fulfill three different functions of writing, reading, and erasing. Another impediment is the demand that both states should be stable in a thermodynamic sense, i.e. of the same energy. In operation, this cannot be realized as one of the two states will always lie on a slightly higher/lower energy level. As a result, for the system to remain stable, a sufficiently high activation barrier has to lie between the states, or a continuous energy supply must be provided with a higher energy level to avoid unwanted switching of the states. Finally, the need for the development of lasers working in the necessary radiation range that may not be easily available, e.g. ultraviolet range will be problematic. Therefore, there have been limited efforts to use photochromic materials for electronic paper research, however, there may be particularly useful application in low-light environments for such a system, e.g., in astronomy, microscopy or even in military display systems, e.g., in submarines as part of a low-light display system.

Thermochromic dye systems (Thermal Stimulus). Thermochromism is the reversible change in the spectral properties (a visible color change) of a substance that accompanies heating and cooling. Vanadium oxide is one of the best known of these compounds because its transition occurs close to room temperature, but its spectral range of switching is located in infrared region and doping has been found with very little effect to shift the spectral range to the visible region. Bistable thermochromic compositions have been developed capable of visible color changes.

Bistable thermochromic compositions, based on their mechanisms and principles of operation can be classified into the following three main categories: (a) polymer-organic crystal; (b) dye complex; and, (c) smectic liquid crystal systems. Polymer-organic crystal thermochromic composition (also known as low molecular-weight system or transparent/opaque type) is composed of a polymer/resin matrix (e.g. polyvinylacetal, polystyrene/polybutadiene copolymer, polyvinylacetate, vinylchloride/vinylacetate copolymer, etc.), and an organic low-molecular weight substance (fatty acids such as stearic acid, behenic acid, etc.) dispersed therein. The second category, dye complex thermochromic compositions, consists of three main components: a coloring agent (e.g. from the group of leuco dyes, lactone dyes, etc.), a developing/tone-reducing agent (e.g. from the group of urea, phosphoric acid, aliphatic carboxylic, phenolic compounds, etc.), and a matrix or binder resin (e.g. steroid, etc.). Reversible coloring and decoloring of the composition is achieved by exposing the system to different thermal energy levels causing the coloring agent and developing/tone-reducing agent to react (development) forming a colored state or to separate (tone reduction) forming a decolored state. The third category, smectic liquid crystal thermochromic composition is based on smectic liquid crystals due to their bistability during phase changes between opaque and transparent states. The basic principle of using smectic liquid crystal materials as a reversible imaging media is similar to their application in liquid crystal (LC) projection displays (projecting optically the information written by means of an incident laser energy or heat-pulse on a liquid crystal display).

In research to demonstrate the feasibility of manufacturing electrical circuit interconnects on different substrates including cellulose-based papers, polyethylene based synthetic papers, etc., via offset lithographic printing, various demonstrator products including reflective thermochromic lithographically printed displays (non-bistable type) have been constructed. Hanada, H., Mitsubishi Paper Mills, Ibaraki Japan, “Trend and development of rewritable thermal recording medium using leuco dye”, J. Imaging Soc. of Japan, vol. 38, no. 2, 1999, pp. 132-136. Hotta, Y., “Evolution and potential of thermal rewritable marking”, Ricoh Co. Ltd., Japan, The international conference on digital printing technologies, IS&T's NIP 17, Sep. 30-Oct. 5, 2001, Fort Lauderdale, Fla., USA, pp. 515-518. http://www.atip.or.jp/fpd/src/present/jssc/24.html. Podhajny, R. M., “Thermochromic materials and their use in packaging”, Paper Film Foil Converter, Jun. 1999, 24. It is reported that several prototype display devices have been fabricated from low cost thermochromic substrates and printed electrode structures. The devices function by heating a localized area of the thermochromic substrate. The electrode structure for each segment consists of a narrow track designed to dissipate a specific quantity of energy as heat.

Fabrication of a thermochromic display includes creation of an addressing system on a substrate followed by applying a film of thermochromic composition. As already discussed, thermochromic compositions, most preferably the dye complex system, can be easily prepared by blending the components including color forming agent (e.g. from the group of leuco dyes, lactone dyes, etc.), color developing/tone-reducing agent (e.g. from the group of urea, phosphoric acid, aliphatic carboxylic, phenolic compounds, etc.), matrix or binder resin (e.g. steroid, etc.) and a suitable solvent or dispersant agent. These starting materials are available and purchasable either in the form of commercial or analytical grades. The blend can form ink wherein the components are dissolved or dispersed. The ink can be coated or printed with various techniques on a plastic or paper substrate. Different properties of the ink such as viscosity, film formation, film adhesion, etc., can be adjusted by varying the concentrations or using proper additives to suit the relevant base layer and coating/printing technique. There are also several suppliers of thermochromic inks. Thermochromic inks based on liquid crystal technology and leuco dyes are commercially available. The advantages of such a display is the possibility of being integrated with paper substrate, use of low cost materials, simple construction, flexibility, fold-ability and portability due to the nature of materials involved when used with flexible substrates, e.g. plastics, paper, etc. and possibility of being made lightweight and thin.

A thermochromic display, however, may not meet some important requirements electronic paper due to its drawbacks including: (a) low speed due to lag time (the time taken for an electrical charge to effect a visual change can be in the range of seconds depending on the ambient temperature, thermal conductivity, specific heat capacity; (b) the power dissipation of the assembly; and, (c) difficulties in thermal management, e.g., control of power dissipated by the display elements when high number of elements are used that requires the power dissipation/area of each to be matched to avoid uneven heating and thus non-uniform optical response, poor durability and short lifetime (photochemical/thermochemical decomposition). These drawbacks, however, may not be applicable to, e.g., large area displays (e.g., billboards) where the speed of the change is not as important, as the opacity and the ability of the dye to withstand exposure to the elements or even high temperatures. Smaller application for use with the present invention include: books, newspapers, magazines, wallpaper and even textiles.

Electroluminescent Organics/Polymers (Organic/Polymeric LEDs). Organic light emitting diodes (OLED's) are based generally on molecular organic materials or polymers (also known as light emitting polymers or LEPs). Organic light emitting diodes (OLED's) are light emissive displays. OLED's, due to their emissive nature do not completely fit to the definition of a paper-like display (i.e., working by reflected light and memory effect (no power requirement to keep an image i.e. bistability). However, there may be applications for electronic paper display systems in which they can be easily and simply integrated over a large area on materials such as plastic, paper and combinations thereof, thus generating new applications for low cost, flexible, lightweight, thin, foldable and large area displays similar to real paper. OLEDs can be coated on more flexible cellulose substrates compared with the other technologies.

Flexible LED's are based on a hybrid of polymer and low molecular weight organic molecules, e.g., a guest-host approach wherein the polymer acts as a binder and creates a matrix for the other active constituents (hole transport, electron transport, and emitter) in addition to other appropriate additives. Tang, C. W., Van Slyke S. A., “Organic electroluminescent diodes”, Appl. Phys. Lett., 51, 1987, p. 913. Burroughes, J. H., Bradley, D. D. C., Brown, A. R., Marks, R. N., Mackay K., Friend, R. H., Burns, P. L. and Holmes, A. B., “Light-emitting diodes based on conjugated polymers”, Nature, 347, 1990, p. 539.

Polymeric LEDs can be fabricated in a single active layer sandwiched between two electrodes. The emissive polymers, anodic electrode (an electrically conductive polymer) and aluminum-coated paper (serving as cathodic electrode and substrate) are commercially available. A simple device architecture for a flexible paper-based display begins with paper on which a cathode (e.g., aluminum) is deposited, followed by deposition of an electroluminescent polymer on the cathode and finally an electrically conductive polymer that serves as an anode is deposited on the electroluminescent polymer. Examples of electroluminescent polymers that can be used are Polyflourene, PPV derivatives, etc. The anode can be made of PANI derivatives or polypyrrole.

Emissive polymers and electrically conductive polymers can be processed in solution and can be spin-coated or ink-jet printed on the aluminum-coated paper. Emissive polymers and electrically conductive polymers can be coated layer by layer without patterning to create polymer electroluminescent lamps. When used with the present invention for use as a display, ink-jet printing can be used to deliver the dye in a pattern on the device. Such devices can be thin, large-scale, lightweight, flexible and full-color. Cost of such products is expected to be low due to the proposed materials—for use (conductive polymers based circuits instead of Silicon transistors printed on ITO (Indium Tin Oxide) and cellulose based paper/microbial cellulose instead of glass) and the manufacturing (e.g., reel-to-reel mass production). In the simplest form of display, fixed texts, images, signs, logos, etc., can be patterned on the device to form a light emitting board, poster, etc., for informative or decorative purposes that is simply connected to a power source without any need for addressing.

Electrochromic dyes. Electrochromism is a reversible and visible change in transmittance and/or reflectance that is associated with an electrochemically induced oxidation-reduction reaction. A small electric current at a low DC potential effects this optical change. The potential is usually on the order of 1 V, and the electrochemical material sometimes exhibits good open-circuit memory. The electrochromic optical density change is often appreciable at ordinary temperatures. An important parameter in performance of electrochromic materials is their cycling efficiency, which is the percentage of electrically generated color that can be removed by reversing the current through the system. Paul M S Monk, Sara Maria Vieira and Frederic Delage, “Incorporation of Electrochromes into Paper”, Department of Chemistry and Materials, Manchester Metropolitan University, Chester Street, Manchester M1 5GD (UK). P. M. S. Monk, C. Turner and S. P. Akhtar, “Electrochemical behaviour of methyl viologen within a matrix of paper”, Electrochem. Acta.

One of the best examples of the non-insertion/extraction group are organic dyes such as viologens (dialkyl derivatives of 4,4′-bipyridinium salts) in a liquid electrolyte vehicle wherein oxidation-reduction takes place. Coloration may be developed by electro deposition rather than within the liquid itself; otherwise, there is drifting of the coloration and poor memory, which are typically troublesome for displaying information with high resolution. Based on the same principle, controlled metal deposition (mainly silver) displays, also called electrolytic displays, are easy to operate, although the realization of only black and white displays is possible. Therefore the use of molecular-based electrochromism (ion-insertion/extraction group) in metal oxides and polymers is the likely to be a preferable choice in certain applications. The members of the ion-insertion/extraction group of electrochromic materials, such as inorganic or organic thin films, including WO₃, MoO₃, Prussian blue (PB, ironIII-hexacyanoferrate II), tetrathiafulvalene (TTF), can be divided into three main categories of transition metal oxides: (a) organic/inorganic dyes; (b) molecular dyes; and, (c) electrically conductive polymers. Electrochromic metal oxides include WO₃, MoO₃, V₂O₅, Nb₂O₅, TiO₂, IrO₂, NiOₓ, CO₂O₃, etc., although WO₃ is the most widely studied and the most attractive candidate. Among the organic/inorganic and molecular dyes, viologens and Prussian Blue (PB) are among the best known electrochromic materials. Compared to other electrochromic materials, transition metal oxides have excellent durability, reliability and stability; however, they suffer from insufficient coloration and slow response times on the order of 15 to 60 seconds or even minutes to achieve 100% conversion to either the colored or bleached state. Narrow color variation and high cost also are other disadvantages of metal oxides. Molecular dyes, on the other hand have better coloration efficiency and faster response time. In addition, color variation due to easier molecular design can be produced over a wide range. However, these dyes may be less durable and less stable compared to metal oxides for certain applications. Besides their advantages and disadvantages, difficulties encountered in processing and fabrication due to sophisticated designs and complicated thin-film formation with the metal oxides and molecular dyes avoid them to be simply, easily, and cheaply incorporated with paper and paper-based products.

To this end, conductive polymers provide a good combination of conductivity, strength, ease of use and the like. Electrochromism is one of the noteworthy characteristics of conducting polymers and is effective in forming conducting polymer images. Changes in the electronic structure of conducting polymers resulting from the electrochemical doping and re-doping results in different absorption spectra, which could be applied for passive display material, e.g., Polyaniline, Polypyrrole, PVDF (Kynar), PPV etc. Conductive polymer electrochromic display devices in their simplest form can be constructed based on a double layer including a conductive polymer film and a solid/semi-solid polymer electrolyte film sandwiched between anode and cathode electrodes.

In one application, text and images can be created and erased repeatedly by applying a DC electric field at 1-2 V potential (with changeable polarity) on top of the electrochromic film in various ways. A cellulose/paper substrate is coated with a thick film of a solid polymer electrolyte, which in turn is coated with a thin film of an electrochromic conductive polymer. In the simplest way, a stylus or photoconductor drum or similar devices that carry a desire charge pattern can be brought into contact with the paper-based flexible polymer electrochromic display. Polyethylene oxide (PEO) doped with lithium salts can be used as a polymer solid electrolyte.

Electrochromic technology has several advantages compared to LCDs and emissive displays such as high reflectivity, wide viewing angle, high contrast, high coloration efficiency, brighter color, multiple color possibility, low driving voltage, low power consumption (due to its bistability or open-circuit memory effect whereby no power is required to maintain an image), free from flickering problem, no need of image refreshing, non-emissivity causing no eye strain, no need of polarizers offering good viewability, free from wash-out problem under high ambient light, etc. There are, however, a number of difficulties which seem to have prevented the electrochromic technology being used as display devices. Commercial devices require electrochromic materials with a high contrast ratio, high coloration efficiency, long cycle life, high write-erase efficiency, and fast response time. Therefore, in order to be useful for practical applications, these materials must exhibit long-term stability, rapid redox switching and large changes in transmittance between redox states. Sapp, S. A., et al, “Rapid switching solid state electrochromic devices based on complimentary conducting polymer films”, Adv. Mat., vol. 8, no. 10, 1996, pp. 808-811. Sapp, S. A., et al, “High contrast ratio and fast-switching dual polymerelectrochromic devices”, Chem. Mater., vol. 10, 1998, pp. 2101-2108.

Given the unique nanostructure of microbial cellulose, it appears to be an ideal starting product for the production of electrically conductive nanostructures. A typical methodology for impregnating ionic salts into the structure is as follows: First, the cellulose behavior in pure methanol produces a partially swollen structure which makes it possible to orient the macromolecular structure and hierarchy of the cellulose. When all water is removed, various concentrations of LiCl solutions in methanol are tested with the microbial cellulose product. This is followed by air-drying in an oven, and then maintained in a dehydrating environment until testing. Using such techniques, it was found that cellulose showed a really good conductivity and responded to the applied potential.

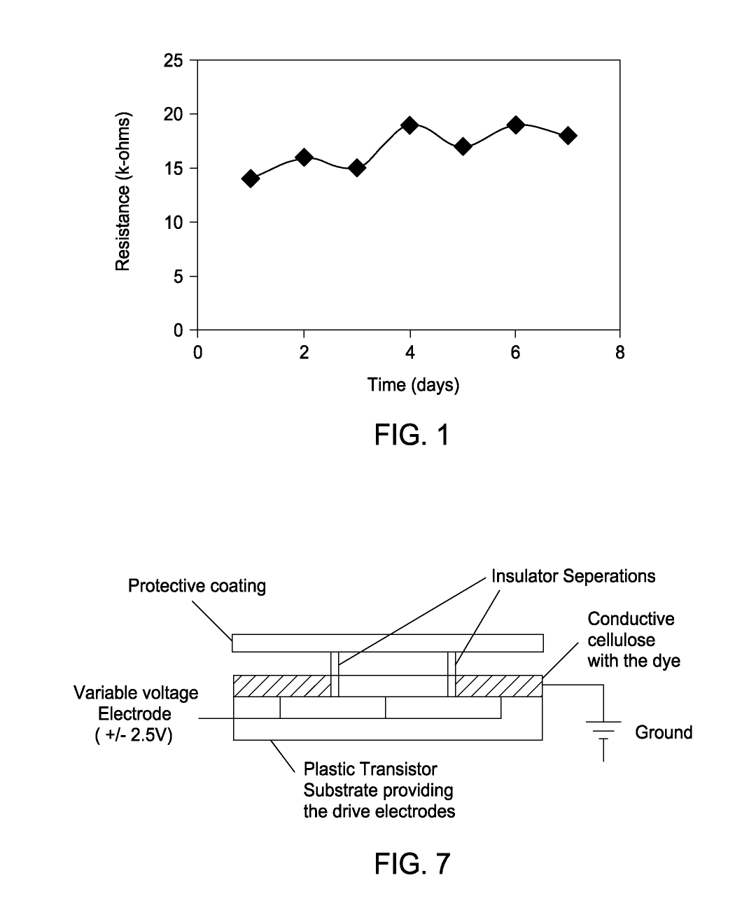

FIG. 1 is a graph that shows the resistance (measured along 1 cm×1 cm substrate) v/s Time (days). The resistance values of this substrate over about 1 cm are plotted with data over a period of 7-8 days, indicating the persistence of the conduction over time. The resistance values fluctuated about the mean value to about +5% and in the above experiment the mean is plotted. However, resistance fluctuated very much in the regime described within the above curve. Without any Li salts incorporated into the cellulose, a typical resistance would be in the order of 30 megaohms. Thus, the salt incorporation increases greatly the conductivity of the cellulose. The conductivity is likely to be ionic in nature, and the morphology at the light and electron microscopic levels shows that the LiCl salts do not cluster and, in fact, are deposited in a very fine layer over individual fibrils.

Images taken with both optical and transmission electron microscopes revealed that there were very few salt crystals in the specimen which suggests that possibly all the ionic salts have become incorporated into the actual nanostructure of the cellulose. In fact, epitaxial deposition of ionic salts onto the ordered surfaces of the microbial cellulose is suggested. There is a possibility of hydrogen bonding of the metal ions with the hydroxyl groups of the glucan chains; however, evidence regarding the actual bonding within the cellulose/salt complex is still needed.

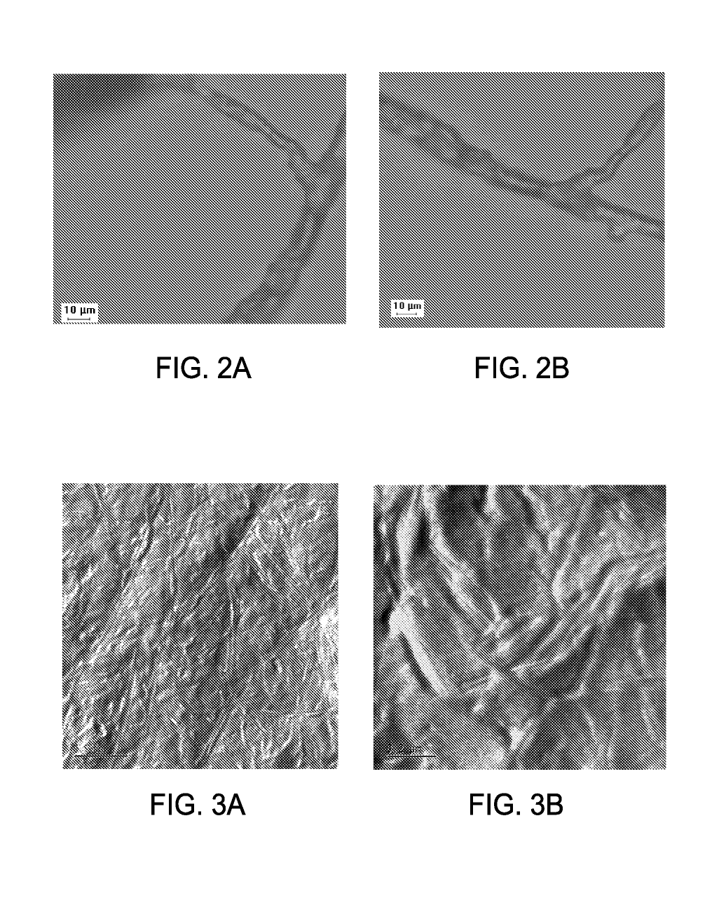

FIG. 2A shows a coated fibril of bacterial cellulose taken in polarization mode in a Zeiss Light Microscope using 16× objective. FIG. 2B is the same fibril rotated 90° to detect orientation. The images in FIG. 2 were taken at about 800× magnification and are captured of individual fibrils which are order of microns wide. A strong birefringence is reflected indicating fibers are oriented parallel along the axis of fibril.

FIG. 3A is a picture of conductive cellulose taken in TEM at 3000× magnification, scale bar is 0.5 μm, while FIG. 3B is an image of same structure at a magnification of 27,500× and the scale is 0.2 μm. The images at lower magnification of the TEM images also show that clusters are absent in the submicron structures (scales are in the order of 0.5 and 0.2 microns respectively. Further higher resolution images were captured to detect salt clusters.

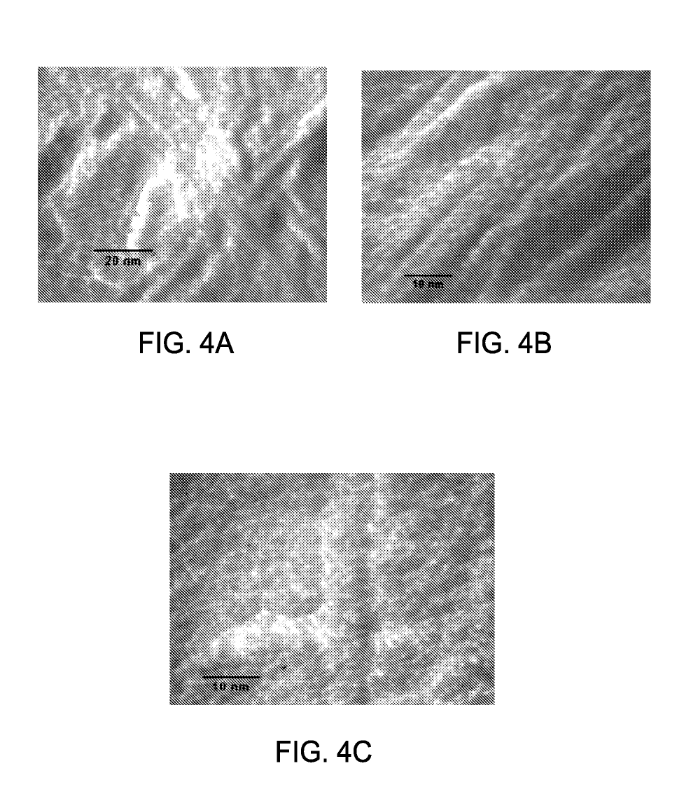

FIG. 4A is a TEM Image of conductive cellulose at 12400×, FIG. 4B is an image taken at 27500× magnification in TEM at 0 tilt, FIG. 4C is an image taken with a 35° tilt at 27500× magnification. The camera used in these three images adds another 18× magnification. It is possible to observe the bright spots that are likely to be salt clusters coating uniformly the fibers. These figures demonstrate two specific embodiments of the present invention: (1) the coating of the fibers to make them conductive; and (2) the ability to coat the fibers at a submicron level.

The high resolution TEM images may show that salt structures decorate the fibrils of the cellulose. The Li ions appear to form a nanostructure, which is of the order of about a nanometer in size. This is an example of nano-deposition of salt nano-crystals along the fibrils. As such, it is likely that the conductivity developed herein may be due to the mobility of ions or mobility of the excess electron through the necklace of positively charged ions. The form of attachment may be hydrogen bonding. Another study with running water supports the possibility that the configuration is in fact hydrogen bonding because the various ions were washed off as water forms much stronger hydrogen bonds with cations.

Studies using varying solute concentrations yielded expected results, and the degree of salt crystallization in the structure was reduced further with reducing concentration of impregnating solution. Also, work with some very thin bacterial cellulose pellicles (possibly about 50 μm in thickness) produced similar results. The following graph indicates the variance in resistance values with respect to the concentration of LiCl (in methanol). In some embodiments it may be useful to sandwich the salt impregnated fibers between layers that insulate the organic fibers from the environment, e.g., plastic, to prevent changes in moisture of the coated fibers.

The LiCl salt structures appear to decorate the cellulose fibers covering the entire cellulose microfibrillar structure uniformly. Microfibrillar cellulose is crystalline and belongs to the cellulose I allomorph, which includes two different sub-allomorphs: cellulose Iα and cellulose Iβ, both of which may be useful with the present invention alone or in combination. For example, cellulose Iα may be used for certain application, e.g., as an electronic paper substrate and cellulose Iβ for other portions of the paper-circuitry. In another example, nematic ordered cellulose may be used in combination with crystalline cellulose I (as synthesized by Acetobacter or as reprecipitated to form cellulose II (Rayon) by synthetic post-synthesis approaches). The fibers observed in the TEM micrographs 4(a) to 4(c) show clear evidence of structures of the size less than 10 nm. The LiCl particulates coating the cellulose microfibrils range from 2 nm-7 nm, and these coat microfibrillar aggregates with a total width of about 3-4 nm (however, those of skill in the art will recognize that metal shadowing of the replicas may produce slightly larger actual sizes for the cellulose fibrils). The deposition of LiCl on the cellulose fibrils appears to be highly epitaxial in nature and serves as a good example of binding biopolymers by inorganic molecules. The homogeneous and continuous coating of LiCl over the cellulose is probably responsible for the relatively high conductivity exhibited by the cellulose. The exact nature of bonding of salts with cellulose microfibrils is not known but is believed to be hydrogen bonding (hydrophilic) or Van der Waals (hydrophobic) in nature as opposed to ionic or covalent bonding. While further studies may be necessary to determine the exact structural relationships between the LiCl crystals and the cellulose, the present invention is not limited in scope to any specific theory or operation.

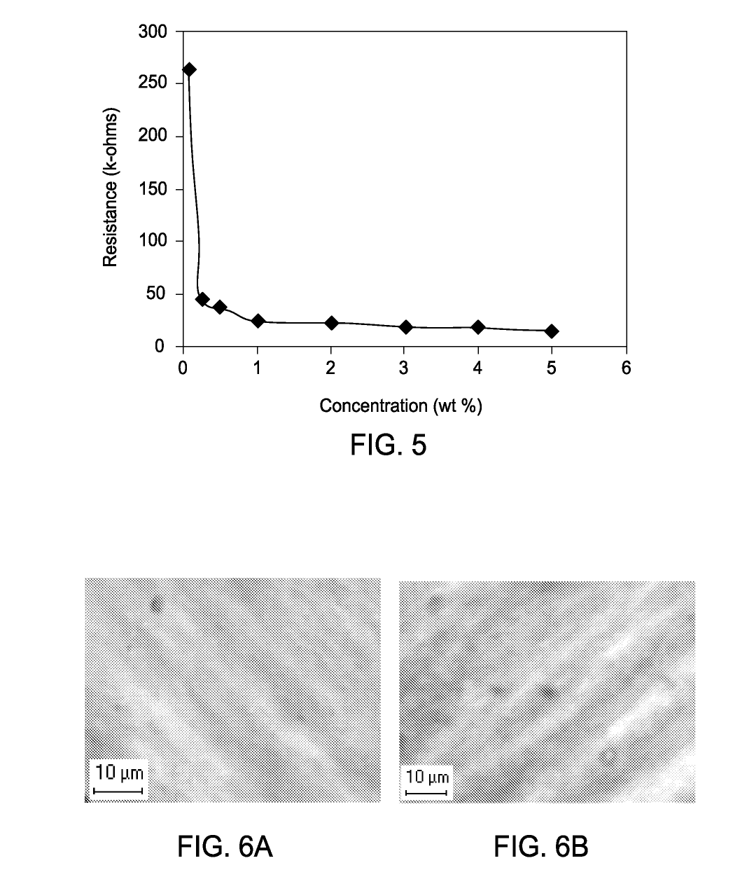

FIG. 5 is a graph that shows resistance (measured along 1 cm×1 cm substrate) v/s concentration of LiCl in methanol (wt %/vol). An approximate calculation with the measured resistance values was done to yield the conductivity. The thickness of the membrane was calculated using the interference spots and with the known cross-section areas an approximate value of conductivity of conductive cellulose with 5% LiCl was about 40 S/cm. Table 1 compares this to the conductivity of metals and other known conductive polymers is illustrated.

TABLE 1
Comparison of known values of conductivity of known conductive
polymers and lead with microbial cellulose.

| Material | Conductivity (S/cm) |
|---|---|
| Metallic Lead | 4.8 × 10⁴ |
| Polyacetalylene | 10²-10⁵ (stretched) |
| Polyaniline | 10-150 (heated) |
| Polypyrrole | 10-10³ (stretched) |
| Conductive Microbial Cellulose | ~40 |

Another interesting phenomenon with the thin bacterial cellulose pellicles was that we could reorient the internal microstructure of the fibers along any direction simply by applying a micro-force using forceps.

FIG. 6A is a picture of conductive cellulose taken at 16× polarization optics in light microscope, and FIG. 6B is a picture at the same setting but rotated 90° to indicate orientation. Fibers aligned along a particular direction giving a more uniform structure should yield especially promising properties for applications such as extremely thin sheets electronic paper and also in paper-thin batteries and cells for generating power.

Electronic Paper. Using microbial cellulose modified in accordance with the present invention, it was possible to demonstrate its uses in the application as electronic paper. Electrochromic dyes were used in this study (e.g., Methyl Viologen and Tungsten trioxide). These dyes in their inherent thin film states show a color change upon application of a potential. The color change is reversed when an opposite potential is applied. Conducting substrate and dyes on the surface should in principle induce a similar color change in them upon application of the potential. By using a combination of dyes and their colored states-native and mixed, a display with a variety of different shades is possible.

Thus, studies were conducted with the electrochromic dyes methyl viologen and tungsten trioxide, on the conductive cellulose substrate. Among these, tungsten trioxide failed to show the color change, due possibly to the improper technique of deposition of the thin film. The Methyl Viologen film did show its characteristic color change, which is colorless to reddish blue, at the regions where the negative electrode (cathode) was attached. The color was completely erased upon the application of reverse potential. This whole process used up a relatively low potential (1.0-2.5V). Further studies have demonstrated color changes of these dyes in the solid state when current is applied to the nano-coated cellulose.

In addition to the above studies, electronic control devices and structures were developed for use with the electronic paper device. The basic concept is that each separated area on the sheet of substrate with dye in it is attached by an electrode that can supply anywhere between +1.5 to 2.5 V. The potential for change depends on the particular dye, for methyl viologen, the potential varies from between about 1.8 to 2.5 V. This is possible by simple passive or active matrix circuitry that is commonly employed in today's display devices. In certain applications, the structure will require a protective coating or passivation layer on top to protect the microbial cellulose from moisture and preserve the dye. The top surface and microbial cellulose will be grounded for relative electron flow with the drive electrode.

An Indium Tin Oxide (ITO) transparent electrode was used to drive the variable electrochromic reactions described herein (see below). ITO electrodes are transparent electrode generally used for, e.g., spectro-electrochemical measurements and display coatings. ITO electrodes may be made by printing on a substrate, e.g., a quartz plate to form electrode using, e.g., vacuum evaporation methods. The ITO layer thickness may be about 100 nm, with an electric resistance of about 20 Ohms. ITO electrodes are also able to transmit light in visible range. In addition to ITO vacuum evaporated type flat electrode, other types of ITO electrodes include: ring disc shape electrodes, split disc shape electrodes and interdigitated array electrodes.

FIG. 7 is a cross-sectional view of a device 10 for use with, e.g., an electronic paper display device with all the various components illustrated. A substrate 12, e.g., cellulose, silicon, plastic and the like has disposed thereon drive electrodes 14 on which is disposed a dye-impregnated conductive cellulose layer 16. A voltage, e.g., 2.5 V may be passed across the transistors 14 to change the reflectivity characteristics of the variable reflectivity dye that is impregnated on the cellulose layer 16. Insulators 18 may also be provided to prevent leakage. The dye-impregnated conductive cellulose layer 16 may be provided with a ground 20. The entire exposed surface of the device 10 may be coated with a passivation layer 22 that serves as a protective coating for all or portions of the device 10. The whole microbial cellulose can be cut out into blocks with insulating partitions in between. The exact materials for these partitions still needs to be investigated but its properties should include homogeneity with cellulose substrate, insulation and ability to print it in micro-scale over the cellulose substrate using an easy technique. The functioning of such a device with changing the addressing pixels is illustrated in the text that follows.

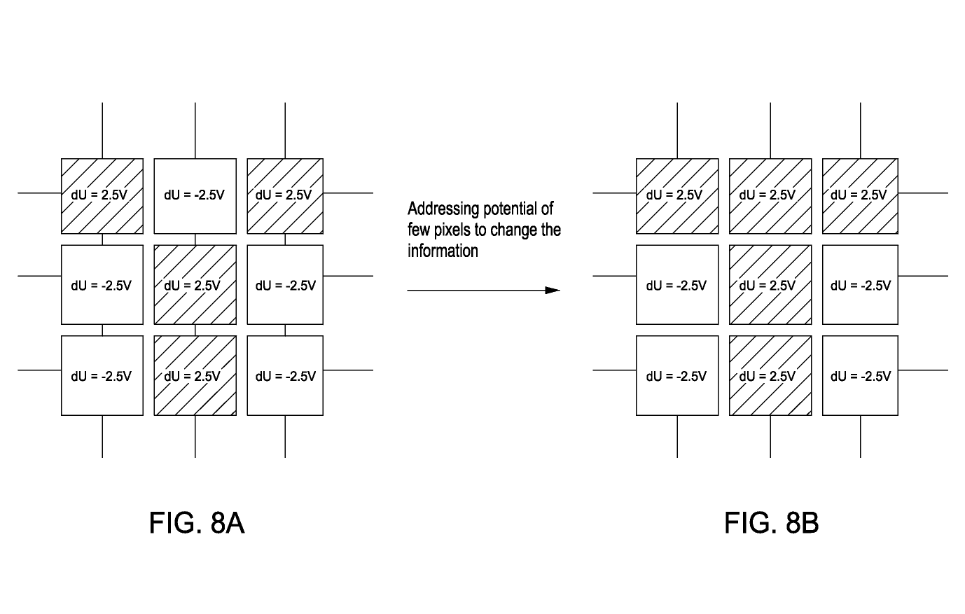

FIGS. 8A and 8B is a top view of nine separately addressable variable reflective dye regions that form part of an array for the variable display of information using, e.g., the semiconductor, cellulose or mixed semiconductor-cellulose-based integrated circuit devices. A particular image displayed at certain potentials across the pixels 8b change in the image upon changing the potentials for nine separately addressed dye regions or pixels.

The characters can therefore easily be displayed by changing the addressing potentials of various separated regions. Each pixel may be, e.g., about 15×15 μm in size for medium to high resolution purposes. Using the present invention and basic electrical control circuit design, in conjunction with one or more variable reflectivity dyes, a display device is prototyped that takes advantage of the best features of cellulose (e.g., stained microbial cellulose) as relates to flexibility, opacity, reflectivity, mechanical properties and/or color (e.g., of paper), may be combined with the change in reflectivity of dyes (e.g., electrochromic, a thermochromic, a magnetochromic, a ionochromic, a light sensitive, a fluorescent, a fluorescent effect energy transfer dye or combinations thereof), that do not require additional energy (e.g., battery power) to maintain their reflectivity state. Therefore, the bistable display system of the present invention only requires that power be provided at very low levels, at only the times when the dye reflectivity is to be modulated. Furthermore, based on the selection of dyes, the reflectivity of the dye may be modulated dozes, hundreds, thousands or tens of thousands of times or more, without fatigue.

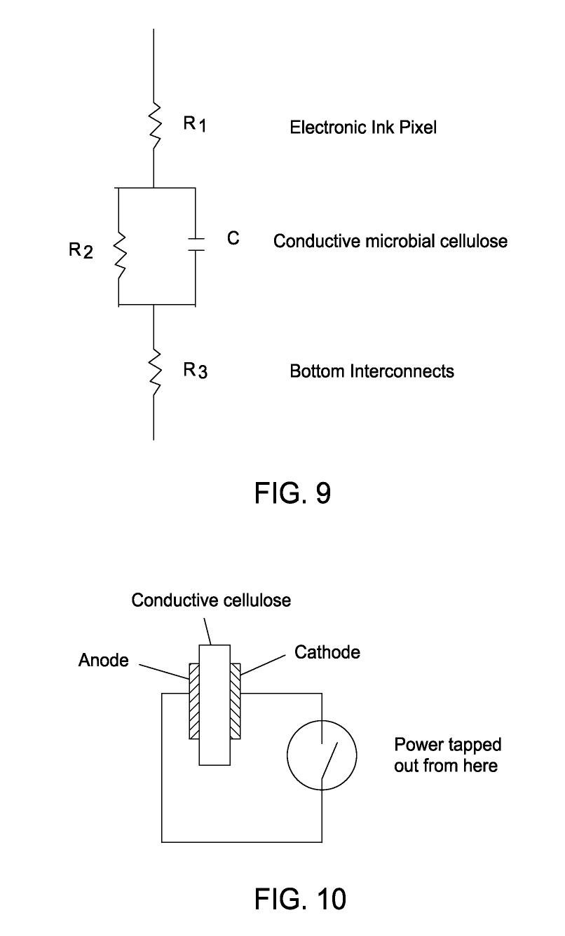

FIG. 9 shows basic resistive and capacitive elements of the materials of the present invention. In operation, an ink pixel would contribute just a resistive element to the circuit R1 and bottom interconnects would contribute a miniscule resistive element R3. The conductive microbial cellulose would have an inherent capacitance that is it will hold certain amount of charge in it due to its dielectric nature. Also, it will have a resistance R2 that has already been measured and documented in the previous section. After an extensive look at the existing literature on displays, it was found that the driving circuit for such a device is relatively straightforward. It can either be active or passively addressed with micro extruded electrodes made of standard integrated circuit materials supplying the variable potential. A flexible transistor circuit is necessary but various research groups have already realized such circuits; and have published their work extensively. As such, one or more integrated circuit devices are possible using the present invention.

FIG. 10 is cross-sectional view of a battery device, in accordance with the present invention, in which the flexibility, conductivity (of conductive cellulose) and insulating capacity of cellulose are used to make a battery. Thus, anode and cathode materials are deposited on the two sides of an insulator (e.g., paper, bacterial cellulose and the like) and generate an ion reaction at both ends involving Li ions reacting at the two electrodes. The anode and cathode electrodes may be, e.g., zinc and manganese dioxide, which may be deposited using, e.g., screen-printing techniques. The advantages of using microbial cellulose to make batteries include: Biodegradability, Abundance and Flexibility. Avoiding harmful chemicals so this wouldn't require casing making it open to other applications like health and skin care.

The concept of electronic paper illustrated herein may be applied to translucent and opaque substrates alike, and depending on dye selection, provide RGB-type color changes that are reusable, persistent and with varying degrees of intensity of the color change. Equipment like cyclic voltagrams and impedance spectrometer could be used to determine the most suitable dyes for different applications. A wide variety of variable reflectivity dyes may be used with the present invention. For example, electrochromic dyes reviewed to date reveal that the intensity of color change in methyl viologen is intense for at least 5000-6000 cycles and more in certain cases. Life cycle determinations may be easily carried-out for different cellulose substrates using the present invention, as will be known to those skilled in the art of display devices.

Another advantage of the present invention is that the dye and salt materials used are relatively cheap, easily available, abundant and in some cases biodegradable. The use of cellulose also has advantages such as biodegradability and abundance, apart from the biggest advantage of making the electronic paper on actual paper with unique types of physical properties.

Cellulose-based integrated circuits. The present invention also provides a cellulose-based integrated circuit device and a process for making the same. In one aspect, the invention includes process steps for the production of an integrated circuit device including the following steps: (1) providing a substrate; (2) patterning a conductive field region to define at least one active area on an upper surface portion of the substrate; (3) forming an insulating gate layer on an active area on the upper surface portion of the substrate; and (4) forming a conductive gate layer on top of the insulating gate layer.

Summarizing, in one embodiment, the process of the invention includes the following fabrication steps in a simplified manufacturing process:

1) Forming or depositing a cellulose substrate;
2) Implanting a partially conductive field in the cellulose substrate;
3) Forming or depositing an electrically insulating layer, e.g., cellulose; and
4) Forming or depositing a conductive layer on the electrically insulating layer to form a gate.

The integrated circuit of the present invention may be used in conjunction with the display device taught herein. In operation, the present invention is described in conjunction with a typical dynamic random access memory (DRAM) cell as it provides a suitable example to demonstrate the application of the present invention to different aspects of integrated circuit formation. A DRAM cell was selected to provide the example as it shows the use of different materials and locations in a transistor, capacitors and conductive lines. Those of skill in the art will readily recognize that the conductive, insulative and other characteristics of the materials and methods of the present invention may be readily expanded to the full range of integrated circuit devices taking into account the necessary changes in conditions of manufacture, device size and the like.

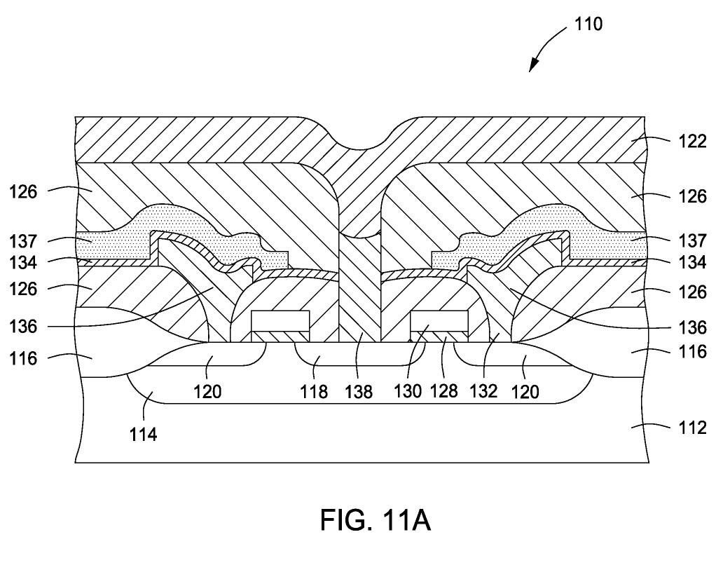

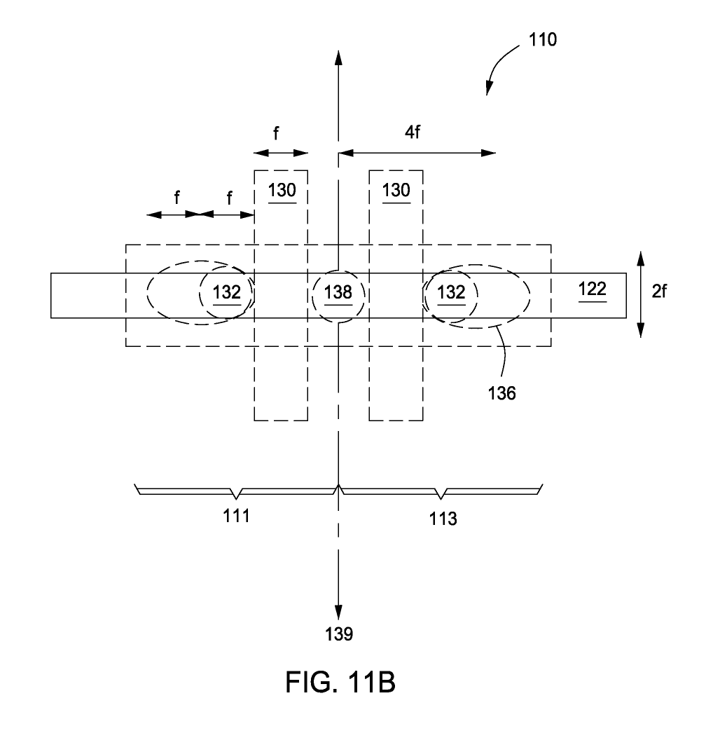

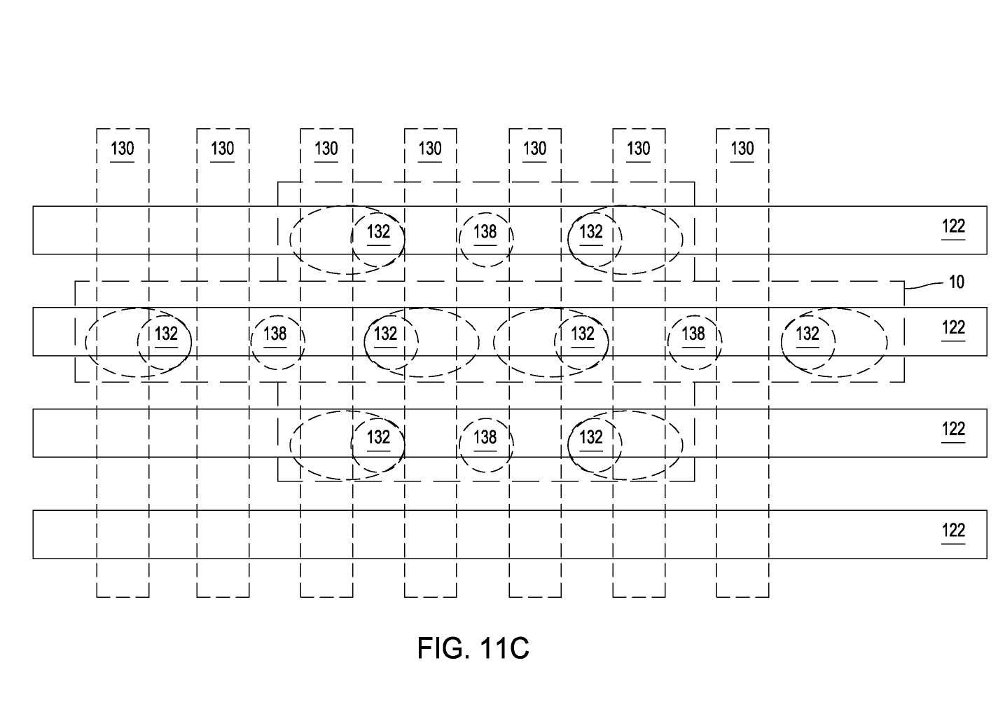

As shown in FIG. 11A, the general features of a pair of cellulose-based DRAM cells of the present invention are generally designated as 110 and are shown as a cross-sectional view. DRAM cells 110 have a substrate 112 that is formed on a cellulose substrate having a conductivity type which may be either a “P-type” or “N-type”, however, in this case the substrate 112 is generally cellulose-based fibrous organic substrate.

In the substrate 112 is cellulose-based, it may be, e.g., fibrous organic substrate that includes, e.g., crystalline native cellulose I, regenerated cellulose II, nematic ordered cellulose, a glucan chain association, chitin, curdlan, β-1,3glucan, chitosan, cellulose acetate and the like, e.g., a cellulose I or cellulose II that further includes one or more subunits or strands of carboxymethylcellulose, methylcellulose, hydroxyethylcellulose, hydroxypropylcellulose and hydroxypropylmethylcellulose or combinations thereof. In some embodiments the substrate 112 may still be made of silicon, gallium arsenide, silicon on insulator (SOI) structures, epitaxial formations, germanium, germanium silicon, polysilicon, amorphous silicon, and/or like substrate, semi-conductive or conductive. For example, when used in conjunction with a display, the control circuitry may still be made of an underlying silicon-based integrated circuit control circuitry and a cellulose based display surface in which the variable reflectivity dye is located and the extend of reflectivity is varied based on inputs from the silicon-based circuitry. Such a mixed silicon-based and cellulose-based system permits the user to maximize the advantages of the optical properties of cellulose, such as reflectivity, flexibility and the ability to take-up one or more dyes with the known manufacturing techniques of silicon-based semiconductor fabrication. Alternatively, the cellulose may be relatively transparent to provide for a see-through display. In another embodiment, the control circuitry, the portions of the substrate that contain the variable reflectivity dye and even the power source may be made almost entirely from cellulose-based materials.

A moat or active area region 114 is shown disposed within an insulative field region 16 which has been grown, formed, deposited or implanted in the substrate 112, e.g., Lithium or other ions. Ions for implantation are selected based on their conductivity, isolation, diffusion rate, etc. The moat region 114, generally formed by diffusion, has disposed therein conductive source/drain regions 120. The common source/drain 118 (common to both cells), located within moat 114, is connected to bitline contact 138 that may be grown, formed, deposited or implanted through an insulating layer 126.

Disposed adjacent to the conductive regions 120, and the common source/drain 118, are gate insulators 128 and wordlines 130. Portions of the wordlines 130 also function as gates, which define the field effect transistors (FET) of the DRAM cells 110. The storage nodes 136 (lower plates of the capacitors) of the DRAM cells 110 are electrically connected to the conductive regions 120 by storage node contact 132. A storage node 136, dielectric layer 134 (e.g., non-conductive cellulose) disposed over the storage node 136 and grounded upper plate 137 form the capacitor. The various components of the DRAM cell 110 are electrically isolated by insulating layers 126. The bitlines 122 and the wordlines 130 may be made of conductive cellulose or other electrically conductive materials that are compatible with the cellulose substrate. One advantage of using cellulose or other organic fibers is that features may be patterned without a need to resort to high temperatures, harsh chemical treatments (e.g., etches and washes) and the like.

FIG. 11B is a top view of the design layout of a pair of cellulose-based DRAM cells 110. Divided across centerline 139 are two 8f2 sized cells 111, 113 that define the DRAM cells 110. As best viewed in conjunction with FIG. 11A, a bitline contact 38 is disposed spanning one-half of one f unit across both 8f2 cells 111 and 113 of the DRAM cells 110. Bitline contact 138 is located centrally over the common source/drain 118. Located at a distance of one f unit on either side of bitline contact 138 are storage node contacts 132, which contact storage node 136 through conductive regions 120 to connect to the capacitor which is above the wordlines 130 and the storage node contacts 132. Wordlines 130 have a width of one f unit, which is generally the same as the diameter of the storage node contacts 132. Perpendicular to the wordlines 130 is a bitline 122 that is depicted atop the units 111 and 113 and which forms an electrical contact with bitline contact 138. Bitline 122 also has a width of one f unit and is longitudinally centered over the DRAM unit cell 110.

FIG. 11C shows a simplified layout of four pair DRAM unit cells 110 of the prior art from a top view. Following the standard rectangular 8f2 design rule along centerline 139, the positioning of bitline contacts 138 relative to each other and of storage node contacts 132 relative to each other, are best viewed in plan view. As is apparent from the top view, the bitline contacts 138 are disposed at a minimum distance of three to three and a half f units when measured horizontally, vertically, or diagonally. The top view highlights the large gaps that exist between storage node contacts 122, for example, a distance of up to three f units. These large distances between bitline contacts 138 and storage node contacts 132 (collectively, self aligning contacts (SAC)), cause large problems during photolithography because dark areas are difficult to achieve when using Levenson Phaseshift. In such a case, the cells may be arranged hexagonally, as taught in U.S. Pat. No. 6,342,420, relevant portions incorporated herein by reference.

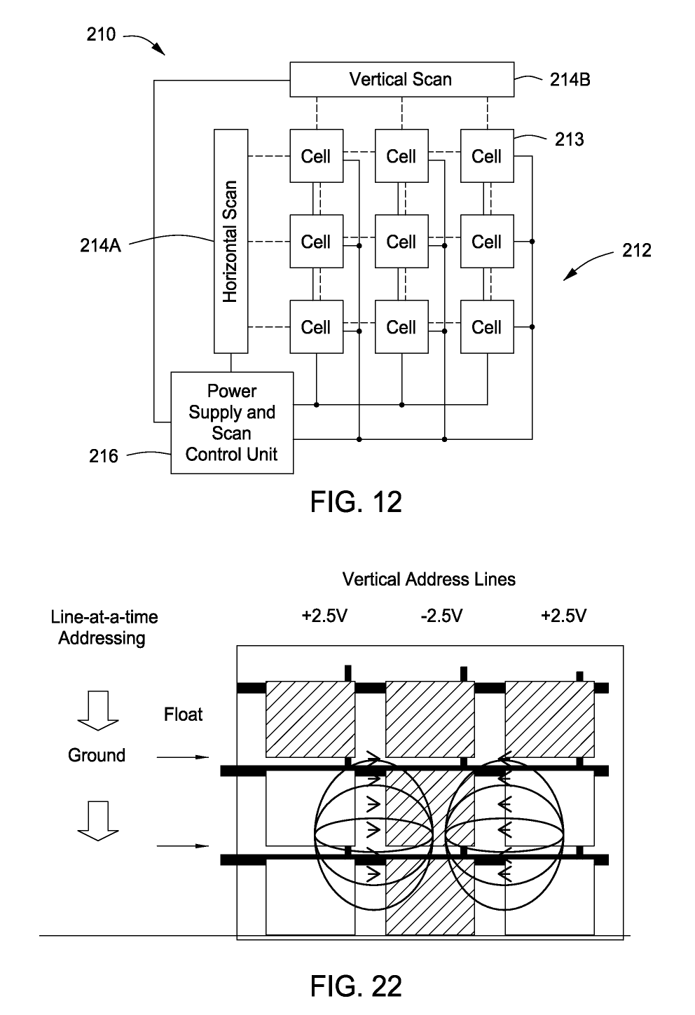

Yet another example of the uses of the conductive cellulose of the present invention is a cellulose-based fingerprint sensor. By way of background, referring now to FIG. 12, there is shown a block diagram of a user input device 210. User input device 210 is preferably integrated into a single cellulose chip, and it includes an array 212 of sensors or pixel cells 213. For purposes of illustration, array 212 is shown comprising nine cells 213. In an actual device, more than nine cells would more likely be included. Each individual sensing cell 213 represents one pixel of the array 212 and is generally smaller than the width of a fingerprint ridge. Enough cells 213 are included in array 212 so that several ridges and valleys of a fingerprint may be detected. In one embodiment, pixel cells 213 are on a pitch of approximately 50 micrometers, which corresponds to a resolution of approximately 508 dots per inch (dpi) for a fingerprint image. Device 210 includes a horizontal scanning stage 214a and a vertical scanning stage 214b. Scanning stages 4 and 5 enable detection from one cell in array 212 at a time according to a predetermined scanning pattern. Input sensor device 210 includes a power supply and scan control unit 216. Power supply and scan control unit 6 supplies a reference voltage to each cell 213 of array 212. Power supply and scan control unit 216 also operates to scan stages 214a and 214b to produce the desired scanning of cells 213.

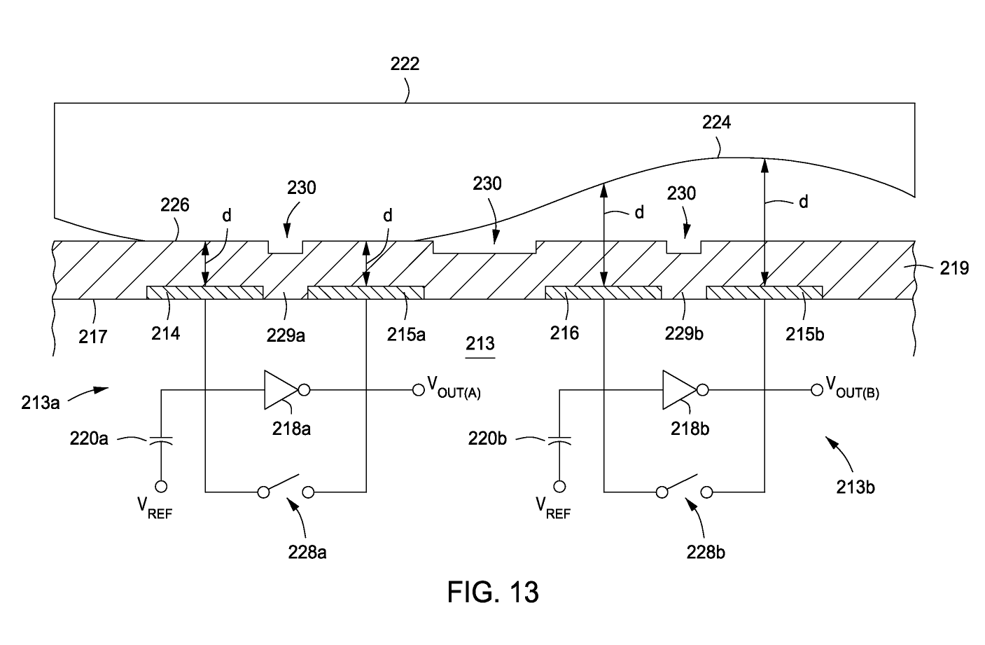

By way of further background, referring now to FIG. 13, there is illustrated the structure and operation of a cell 213. A cell 213 for use with the present invention may be of the type disclosed in Tartagni, U.S. Pat. No. 6,114,862, entitled “Capacitive Distance Sensor,” relevant portions incorporated herein by reference. The technology of this example of the present invention uses an active pixel design based on a capacitive feedback sensing circuit. Each 213a, 213b includes a first conductor plate 211a, 211b, respectively, and a second conductor plate 215a, 215 b, respectively, supported on a substrate (not depicted), which may be, e.g., a non-conductive cellulose substrate or even a conventional silicon substrate that may have a shallow epitaxial layer at an upper surface region 217 of the silicon substrate. The top surface of the substrate includes an insulating layer 219. Insulating layer 219 is preferably a non-conductive layer, e.g., a transparent cellulose layer, which may be a conventional deposited cellulose layer. Insulating layer 219 may further include a protective or passivation coating of a hard or ultra-hard material, e.g., a plastic, a glass or even an ultra-hard surface such as silicon carbide, silicon nitride or a combination of silicon carbide and silicon nitride. With an added protective coating, insulating layer 219 protects sensor 213 from abrasion, contamination, and electrostatic discharge.

Each cell 213a and 213b may include, e.g., a high-gain inverting amplifier 218a, 218b, respectively. The input of amplifier 218a or 218b is connected to a reference voltage source Vref through an input capacitor 220a, 220b, respectively. The output of each amplifier 218a, 218b is connected to an output Vₒᵤₜa, Vₒᵤₜb, respectively. The input of each amplifier 218a, 218b is also connected to the respective conductor plate 211 and the output of each amplifier 218a, 218b is also connected to the respective conductor plate 215a, 215b, respectively, thereby creating a charge integrator whose feedback capacitance is the effective capacitance between the two conductor plates 211a and 215a or 211b and 215b.

When no object is placed on the surface of insulating layer 219, the effective capacitance between plates 211a and 215a is the fringing capacitance seen through layer 219 and the air near the surface of the sensor at region 229a and/or 229b. The distance between plates 211a and 215a at region 229a may be approximately 2 microns. When an object 222, such as a finger, is placed on the surface of insulating layer 219, the conductive properties of the object (e.g., skin surface) and the proximity of the object to the sensor surface will act to modify the capacitance coupling between plates 211a and 215a, in the example depicted. The object is separated from plates 211a and 215a by a total dielectric layer that includes both the insulating layer 219 and a variable thickness of air between layer 219 and the object 222. Because fingerprint valleys or pores 224 will be farther from the sensor surface than finger ridges 226, sensor 213b beneath the valleys or pores 24 will have more distance between their conductor plates 211b and 215b and the skin surface than sensors 213a under ridges 26. The thickness “d” of this total dielectric layer will modulate the capacitance coupling between plates 211a, 211b and 215a, 215b of each cell 213a, 213b. Accordingly, sensors 213 under valleys or pores 224 will exhibit a different effective capacitance than sensors 213 under ridges 226. As shown in FIG. 12, the effective capacitance of sensor 213a is different from the effective capacitance of sensor 213b. Vₒᵤₜa will differ from Vₒᵤₜb since Vₒᵤₜ is inversely proportional to the effective feedback capacitance.

Scanning stages 4 and 5 of FIG. 13 operate to sequentially enable the reading or interrogation of the many cells 213 within array 212. Sensors 213 work in two phases. During the first phase, the amplifiers 218a, 218b are reset with a switch 228a, 228b, respectively, by shorting the respective input and output of amplifier 218a and/or 218b. Resetting the input/output causes the amplifiers 218a, 218b to settle at the logical threshold. During the second phase, a fixed charge is input to the amplifier, causing an output voltage swing inversely proportional to the feedback capacitance, which is the effective capacitance between conductor plates 211 and 215. The effective feedback capacitance is now the capacitance between plates 211 and 215 seen across the total dielectric at a distance “d” which includes layer 219 and air between the object 222 and the top 226 of layer 219.

For a fixed amount of input charge, the output of amplifier 218 will range between two extremes depending on the effective feedback capacitance value. The first extreme is a saturated voltage level if the effective feedback capacitance is very small. The second extreme is a voltage close to the logical threshold, which is the reset value, when the effective feedback capacitance is large. Since the distance between the skin and the sensor changes the effective feedback capacitance of the charge integrator, the output of sensor 213a under ridge 226 will be different from the output of sensor 213b under valley 224. The entire fingerprint pattern can thus be digitized by sensing the differences in adjacent pixel cell capacitive values. It is also important to note that a conductive path to ground should be provided to or around each pixel (not shown), such that an electrostatic discharge is dissipated though the conductive path to ground rather than through the circuitry of the pixel and to ground. To be effective, such electrostatic discharge layer must present a more conductive path to ground than any paths to ground through the internal circuitry of the pixels and any dielectrics insulating the circuitry from the environment.

The structure and method of the present invention may be used with a wide variety of imaging sensors, such as the fingerprint sensor described herein by way of example, and as will be known to those skilled in the art in light of the present disclosure. As noted above, in using the described capacitance-coupled sensor, resolutions of up to 508 dpi can be achieved. With improvements in image processing algorithms, sensors having a resolution of 750 dpi, or more, can be expected. For use in sensing fingerprint valleys and ridges, an array 212 of sensors 213 is used to sample the fingerprint pattern. The entire chip may also contain additional timing and voltage controls and references in addition to the above described controls and references.

The structure and method for forming a capacitively-coupled fingerprint sensor on a cellulose substrate may be reversed to place a capacitance coupled charge on a portion of the surface of the insulator 219 that has been impregnated with a dye. Using existing scanning technology, a display device may be made that provides a change in reflectivity of a dye on the surface. In fact, both technologies can be combined where a change in color occurs when an object couples the capacitance sensors thereby triggering a change in the dye conditions to increase or decrease reflectivity of a dye or dyes on the surface 226 of the insulator 219.

In one study the following results were obtained. Samples of bacterial cellulose were acquired in dry and wet states. The following solution was prepared in a beaker:

### 40 mL Acetone

0.5 gr tetrabutylammonium hexafluorophosphate salt
1.5 gr propylene carbonate
0.9 gr Kynar2801 polymer
0.08 gr methyl viologen

### 0.09 gr Hydroquinone

Kynar 2801 was the conductive polymer used to enhance the conductivity of cellulose. The organic dye used was methyl viologen. The couple (hydroquinone) is required for bistability and reversibility. Pieces of dry and wet bacterial cellulose were placed overnight in the solution. The soaked samples with the incorporated polymer electrolyte system were then dried. The samples were then switched between two conducting electrodes, in this case, coated glass acting as electrodes. The two conducting electrodes were connected to the reversible battery source. The effects of applying the reverse and the forward voltages were studied and the visual changes were examined. Different concentrations of doped polymers and dye were tried.

On passing the forward current, the color of the viologen embedded cellulose turns bluish. The current tends to oxidize methyl viologen, which is visible in the form of bluish color at the points of good contact and good dispersion of the dye. On reversing the current, the bluish color disappeared. This is attributed to the reversibility of the electrochemical reaction of methyl viologen: MV [symbol] MV²⁺+2e⁻. The hydroquinone couple acts as the electrochromic couple required for color change reversibility. Without the presence of the couple or with its reduced concentration the color change reversibility was lost. Also, by reducing the concentration of Kynar polymer, the speed of the color change and its visibility was reduced. This is attributed to the decrease in the conductivity of the electrolyte system.

The colorless, oxidized compound is soluble in water as bromide or hydrogenophosphate, while the blue-purple reduced form is insoluble and precipitates as a film upon reduction. Color change was sharp and fast, but one deposited film suffered crystallization, which lead to slow or incomplete bleaching after repeated cycling. The color changes were much more clear and reversible in the wet cellulose system because of the ease of polymer incorporation. Since, the final state of the polymer-cellulose matrix system was dry, however, this was found to pose much of a disadvantage. The use of dry cellulose for incorporating the polymer electrolyte system is problematical because it doesn't absorb the polymer system well.

In order to improve the responsiveness of the system a number of changes were made based on the following calculation for charge movement through the electronic paper. The calculations were derived from measurements on the display device and system of the present invention based on the actual potential applied of +2.5V. The known value of resistance across the 1 cm length: 25 k-ohms and the have an amount of current flowed (assuming the validity of Ohms' law):

I=V/R=2.5/25=0.1 milliAmperes or 0.1 milliColoumbs/sec

Hence, the number of electrons transferred across the 1 centimeter length of the substrate:

$$No . of electrons = 0.1 \times {10}^{- 3} / ( 1.6 \times {10}^{- 19} ) \\ = 6.25 \times {10}^{14} electrons \text{/} second$$

A Methyl Viologen reaction generally requires 2 electrons to form the MV colored state from MV²⁺ state. Hence the number of molecules of MV that should be excited ideally if we assume 100% efficiency is 3.125×10¹⁴ molecules. This corresponds to 5.2×10⁻¹⁰ moles.

The chemical formula for methyl viologen hydrate used was C₁₂H₁₄Cl₂N₂, which corresponds to a molecular weight of 257 gms/mole. Therefore, assuming ideal conditions and 100% efficiency it is possible to convert 1.33×10⁻⁷ grams of methyl viologen on a 1 cm² area of the substrate. The structural formula and dimensions for methyl viologen is as follows

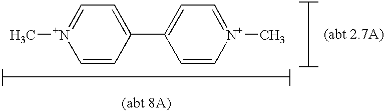

The calculated yields for a 1 cm² area with the above molecule size is a requirement of approximately 4.6×10¹⁴ molecules, which squares with the value of the amount of molecules converted at 2.5 V. Based on these calculations, a monolayer attached to the top of cellulose substrate in ideal conditions can completely be converted to its colored states at an applied potential of 2.5V.

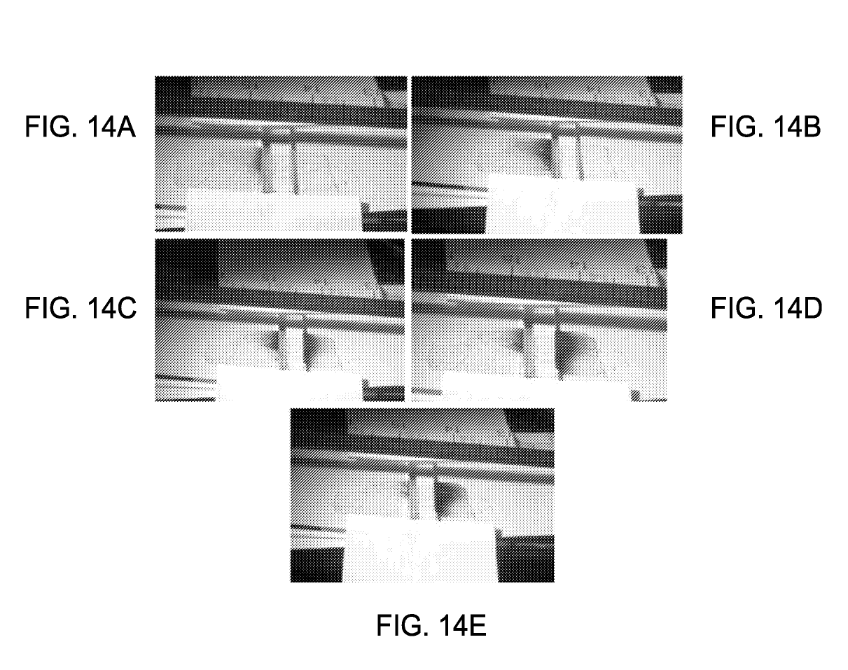

FIGS. 14A through 14E show the results of two clear glass electrodes with a bridge of microbial cellulose which is conducting and which has the methyl viologen dye. A voltage of 2.5 volts was applied and the clear cellulose immediately became colored (upper left). The variable reflectivity dye gets darker as additional electric potential is applied. When the current is reversed, the reflectivity of the opposite side changes and the opposite side returns to a clear state, thereby completing a modulated reflectivity cycle.

Cellulose-batteries. A device such as the electronic display device or paper takes advantage of the paper-like flexibility of cellulose and its flexibility, as such, flexible devices would benefit from a flexible power source. The present invention also includes paper-like and paper-based batteries for applications of flexible devices, e-textiles and body patches. The conductive cellulose substrate in the example of the present invention has predominantly ionic conductivity due to the presence of Li ions in the nanostructure. As shown hereinabove, the Li-cellulose conductor provides Li ions in the useful range for a material to function as an electrolyte, that is, conductivity in range of 1-100 S/cm whereby the electrolyte acts as a medium of ion transport. The cellulose substrate developed as part of, and for use with, the present invention exhibits a conductivity of about 20 S/cm and there is ion movement in the cellulose structure leading to it. Hence, the thin conductive microbial cellulose pellicles actually act as electrolyte for a paper battery.

Yet another application for the conductive and non-conductive organic fibers of the present invention includes “smart textiles.” In this embodiment, the electronic materials based on cellulose are incorporated into, e.g., cotton fibers such as a microbial-cellulose coated cotton fiber or other textile. Alternatively, the textiles may be based entirely on microbial cellulose. In “smart textiles” the cellulose, conductive cellulose or even the color changing cellulose is under external or internal control of a control logic coats one or more cotton fibers (e.g., a cotton fiber that is about 10 μm in diameter and 3-4 cm in length). Color changes to the smart textile may be induced in the cellulose coating to have the clothing changes color and/or its pattern to, e.g., match the background surroundings, serve as advertising, as a novelty, or to change color to match other clothing. In one specific application for the smart textiles, a soldier may, in real-time have dynamic camouflage. For example, color and/or pattern sensors (e.g., small cameras) may be placed about the surface of the garment and as the surrounding colors and/or patterns surrounding the user change, so does the color and/or pattern on the garment surface. Such an application would also find use in friend or foe recognition, where a pattern for, e.g., IR or UV reflective material is patterned for each day so that enemy combatants are unable to pass as allied soldiers.

Yet another embodiment of the present invention is a electronic-paper system that contains on one surface the cellulose-based, variable intensity dye paper of the present invention that is connected to, e.g., a memory cell and/or a control logic. A keyboard may also be connected to such a system to allow the user to type in text that appears, e.g., in real-time on the surface of the electronic-paper system. In one example, the electronic paper may have RGB or other color system dyes imprinted on the paper surface to allow for color on a white, opaque or translucent electronic paper. In operation, the electronic paper may be a billboard and the color, text, pictures, graphics, lines, etc., are modified by a user from the ground and communicated to the electronic paper surface without having to change the entire surface of the billboard.

Yet another embodiment is a laptop-type device in which the electronic paper is connected or part of a computer, where the electronic paper serves as, e.g., an overleaf page that serves as the computer screen. This “computer in a book” laptop type device or system may further include, e.g., a real-time Braille output. In yet another embodiment of the electronic paper, each pixel of the conductive cellulose may be controlled by a potential supplied using, e.g., an ITO covered flexible circuit. To make such a system, the indium tin oxide may be deposited using, e.g., vacuum deposition onto the sub-micron size cellulose. In one such application, the cellulose acts as a conductor and/or a display surface.

Dispersion of Single-Wall Nanotubes/Dye complex into Cellulose. Single Wall Carbon Nanotubes are quasi-1D systems that transport electrons in one dimension. The conduction may be caused by a delocalized cloud of electrons from the overlap of the C—C bond. Carbon nanotubes also have the property of self assembly due to strong Van der waals forces. To make use of these properties, single-wall nanotube dispersion was made in methanol. The dispersion was sonicated to make the dispersion homogeneous. A 2 wt % dye (Methyl Viologen) solution in methanol was added in 1:1 ratio to this dispersion and further sonication was performed to mix the solutions. The solution was dispersed in bacterial cellulose of two different thicknesses. The samples were characterized for conductivity, reversibility of color change (applying +/− potential) and the micro- and nano-structure was characterized using optical microscope and High resolution TEM (Transmission electron microscope respectively).

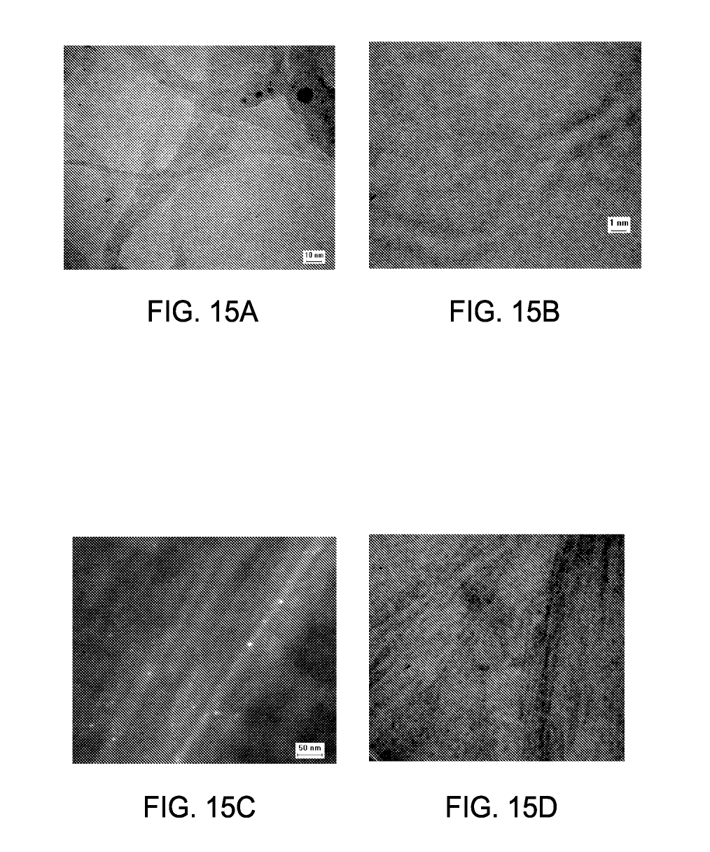

FIG. 15 A through 15D are high resolution TEM micrographs of carbon nanotubes in cellulose showing: (15A) a dispersion of nanotubes in methanol (33,000×); (15B) Resolution of a single nanotube (160,000×); (15C) a dispersion of nanotubes along the fibril (DF, 2,100×); and (15D) a dispersion of the nanotubes along the fibrillar structure of bacterial cellulose (2,100×) (note: magnification & dimensions are same in both images). FIG. 15A indicates the self assembly properties of the nanotubes which make them align into bundles. The nanotubes arrange themselves into bundles forming an interconnected array (33,000×). The dimensions of single nanotube are illustrated in the high magnification image (15B) where a single tube is captured. (The dimension or the width of the nanotube is less than 1 nm as indicated in the scale). (350,000×).

Such a unique nanostructure provides a great opportunity to disperse it with the bacterial cellulose membrane to form a unique structure. After dispersing the nanotubes into bacterial cellulose, the surface resistivity values ranging from 1-20MΩ/cm in the completely dry state are achieved. The dye complex was then integrated then into a cellulose sheet. Following images were captured of the unique nanostructure formed by the dye-nanotube complex in cellulose (2100×/darkfield).

The dye forms nanoclusters (˜15 nm) that uniquely coat the fibrils. The nanotubes form a homogeneous coating of cellulose fibrils as shown in the image 15C (17,000×). The structure did not allow the color change to take place completely in the completely dry state upon application of the reversible potential. However, when a water droplet was placed through the connections, a homogeneous and reversible color change was observed. The reason for this is that hydration makes the microstructure very uniform for charge conduction. The area under the contact of the electrode with high concentrations of the electric field changed color and area of transition of the color to the non-colored regions in cellulose was imaged using an optical microscope (˜900×ca.)

The nanostructure formed by carbon nanotubes and dye in the cellulose is very unique. The cellulose microfibrils (as seen in the HR-TEM, FIGS. 15A to 15D) appear coated uniformly with nanotubes and dye nanoclusters seemed to deposit over the microfibrils' surface. It appears that carbon nanotubes seem to have well integrated with the cellulose forming networks across the surface and the bulk. The dye clusters however, seem to be present uniformly over the cellulose surface. The image in the optical microscope after the color change upon application of the potential seem to indicate that regions of transition between colored and non-colored regions are separated by bundles of microfibrils and cellulose seems to have trapped the colored dye in between. The dye exhibits color when it has two excess electrons/molecule that is excess charge; therefore cellulose fibrils are trapping the excess charge between them. This gives rise to possibilities of use of cellulose fibrils in charge storage on a miniature scale. Cellulose can therefore act as insulator on a very small scale in charge storing devices. Also, charge trapping provides the system with bistability (i.e., the presence of excess charge will maintain the color of the system for prolonged time without external potential).

Conductivity: After dispersing the nanotubes into bacterial cellulose, it gave resistivity values ranging from 1-2MΩ/cm in the completely dry state. If x=1.5 MΩ; Calculated conductivity=0.08 S/cm.

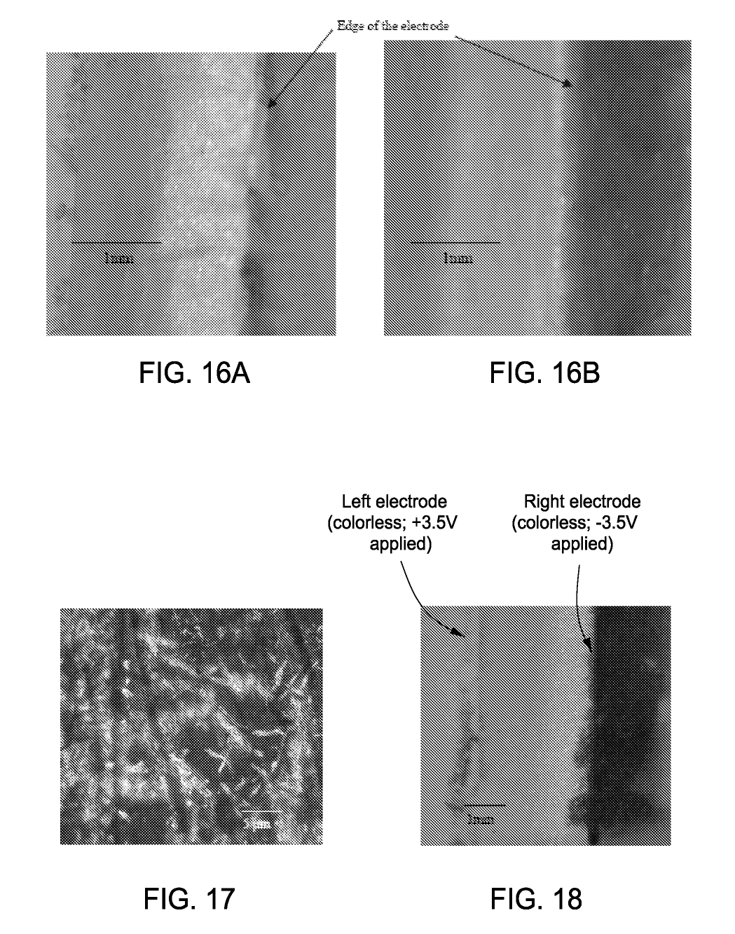

Color changes: With 0.5% polyethylene glycol incorporated in the structure as well, the color change was reversible and homogeneous. The color change took place at around 10 V. FIGS. 16A and 16B illustrate the color change (16B). Edge of the electrode=1 mm. In-plane carbon nanotube-PEG system color change: Bleached (16A; at t=0 s) and darkened side electrode (16B; at t=0.5 s). Again the single cation MV+ state was achieved which was sharp blue in color (FIGS. 16A and 16B). As shown in FIGS. 16A and 16 B, the system has a high contrast and bistability just as the KCl—PEG system (described herein below). Without polyethylene glycol, the color change in the nanotube-cellulose system was incomplete. However, when a water droplet was placed through the connections, a homogeneous and reversible color change was observed. The reason for this is that hydration makes the microstructure very uniform for charge conduction. The dye in the region under the contact of the electrode with high concentrations of the electric field changed color, and the area of transition of the color to the non-colored regions in cellulose was imaged using an optical microscope. These figures indicate that regions of transition between colored and non-colored regions are separated by bundles of microfibrils, and the cellulose seems to have trapped the colored dye in between. The dye exhibits color when it has two excess electrons. Therefore, the cellulose fibrils appear to be trapping the excess charge between them. Note that magenta or disubstituted viologen state is obtained as this membrane was hydrated. This gives rise to possibilities of use of cellulose fibrils in charge storage on a miniature scale.

KCl—PEG system. Next, the dendritic deposition of PEG (Polyethylene glycol) covering bacterial cellulose was demonstrated. In the KCl—PEG system, incorporation of all the active materials together in the bacterial cellulose after one soaking step yielded the best results. FIG. 17 is a micrograph showing the dendritic deposition of polyethylene glycol on the bacterial cellulose surface (Polarization ˜800×). The conductivity obtained was much greater (0.2 S/cm) and color changes more intense and uniform, which is simply because substantial solute can be lost in the second solvent treatment even though the KCl and PEG will be insoluble in methanol. Some of the thin films of the solutes can be etched off very easily from the surface. Hence, the results of this experiment are documented in following sections.

Conductivity: The conductivity of the substrate was:

(A resistance value=‘x’ along a 1 cm×1 cm substrate)

x=600 kΩs

The conductivity ca.=0.2 S/cm

This conductivity was appreciable for color change to occur.

Color changes. The color changes were obtained in the completely dry state for the first time in the bacterial cellulose membrane sheets. In this case due to single electron transfer, the single transfer to an intermediate blue state was obtained as follows:

$$\begin{matrix}{MV}^{2 +} + {e}^{-} \\ ( colorless )\end{matrix} \to \begin{matrix}{MV}^{+} \\ ( blue )\end{matrix}$$

The polyethylene glycol formed dendritic structures on the surface of the membrane. These were observed with high resolution optical microscopy (FIG. 17). The color change was homogeneous and had very good contrast. In the in-plane device, coloration of one electrode with respect to white state of adjacent electrode is illustrated in FIG. 18. FIG. 18 is an image (4×) of color change in the KCl—PEG system (in-plane device). An important advantage of this system was its high bistability (˜30 minutes). Also as evident in the image, the contrast achieved was very high between the two states (FIG. 18). Thus, imaging was successfully demonstrated using the KCl—PEG system.

In combination, the key distinctions between the nanotube and KCl system compared to LiCl-Methanol system are: (1) achieving color change in moisture-free state; (2) achieving color change to a different state from magenta. The color achieved was dark blue instead of magenta state; (3) achieving color change in PEG coated membrane sheet and (4) the issue of hygroscopicity of LiCl is reduced.

Rewritable Device. Color change images of the successful device (from ACS presentation). The rewritable embodiment has direct applications, e.g., an Etch-a-sketch-type device that permits the user to add or remove the image with a tip or stylus, (2) rewritable paper (and similar to PDAs); and (3) dynamic rewritable maps

Another embodiment of the present invention using dye electrochromism in bacterial cellulose is a fixed pixel changing its color reversibly from colorless to dark (or ON OFF). This had the possibility of being integrated into an E-book or E-paper kind of a device. Such a device would be a multi-pixel version of the two kinds of single pixel prototype constructed. In both cases, the two electrodes were rigidly constructed and placed in proximity to the active bacterial cellulose membrane. These prototypes can display images and text which will be addressed by software integrated in the back circuitry.

With the invention of PDAs and digital diaries, there are devices available which are writable using a pen shaped stylus. A most basic example of such a device is an “Etch-a-sketch” which is a rewritable board used for games and learning for children. It is based on movement of dark magnetic particles which can be stuck on or removed from the substrate holding them using a pen shaped magnetic stylus. Following an idea similar to a PDA, a device has been constructed with the upper electrode shaped as a stylus or a pen. The conductive bacterial cellulose membrane is made the same way as before for device the devices described hereinabove. The rewritable device should generally have a uniform dispersion of dye and conductors throughout the various layers.

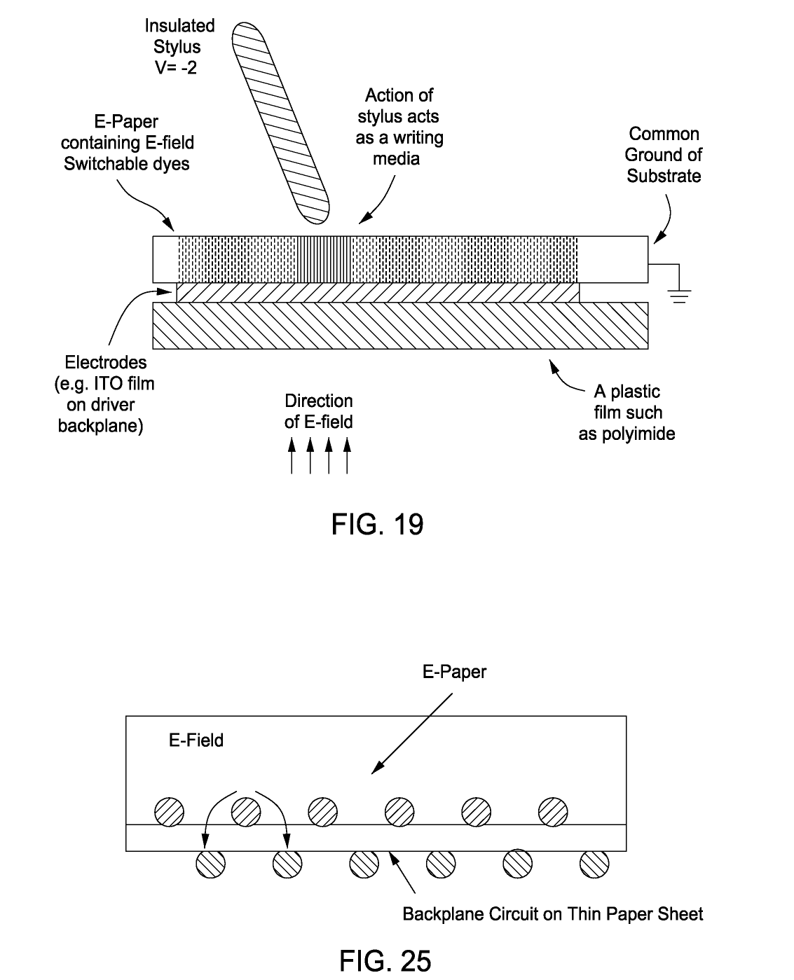

FIG. 19 shows a rewritable prototype using the similar electrochromic principles but constructed with a mobile upper electrode acting as a pen. Hence, the only new idea in this device is the fact that the dye would change color at the very same points where it is in contact with the electrodes. Therefore, the charge transfer process is enabled only in the regions where the circuit is completed by the top electrode touching the membrane. Because of the localization of the stylus tip point creates a strong electric field leading to an almost instantaneous change in the color of the dye at the contact points. Hence, the whole process would exactly replicate in real time the actual writing of ink on a paper sheet. The dye color patterns i.e. the writings created on such a paper device could be rapidly erased by supplying an opposite voltage from the electrode below. Hence, what essentially is achieved in this prototype is a form of rewritable paper. This membrane can be rewritten many times (˜5-10,000 basically limited by the lifecycle of the dye).

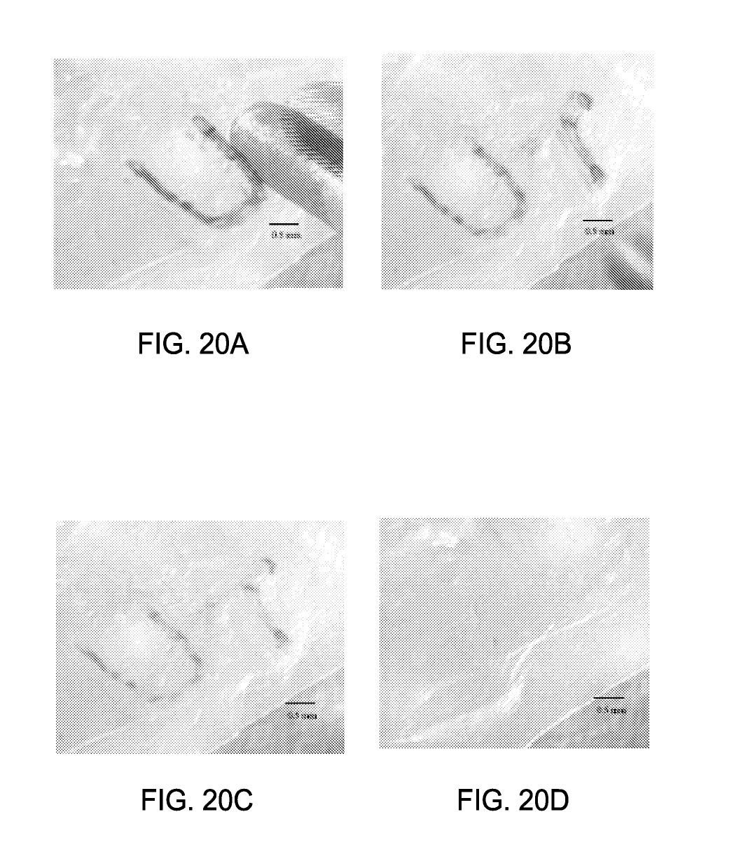

E-Paper containing E-field Switchable dyes. FIGS. 20 A to 20D show the results with the rewriting of the conductive BC sheet (20A) is instantaneous writing and (20B), (20C) and (20D) are pictures of erasing of the prototype by opposite field. The present invention include reusable paper that can be used to transcribe notes many times, thus serving functions of a PDA or a tablet PC. Also, since this device does not involve complex circuitry or complex fabrication, it should be made very inexpensively. It can take the form of a learning tool for children such as an Etch-a-sketch. The paper-like appearance would make this device much more appealing than an Etch-a-sketch. It can also take the form of rewritable maps that can be wirelessly carried over the field by soldiers allowing them to record information again. Upon integration with user interface software like a PDA, the text written on the electro-optic film can be stored in a digital form. The advantages associated with this device include: (1) the full scale functional prototype of this device does not require addressing by an integrated circuit. Hence, it is relatively inexpensive and simple; (2) the flexibility will not be a function of the stability of the back circuit. Therefore, a complete paper-like fold ability and flexibility can be achieved. (Indium tin oxide foils have been shown to be very stable and amenable to bending); (3) The color change takes place instantaneously meaning there is no lag between the electrode movement and writing. Hence, this directly simulates writing on paper.

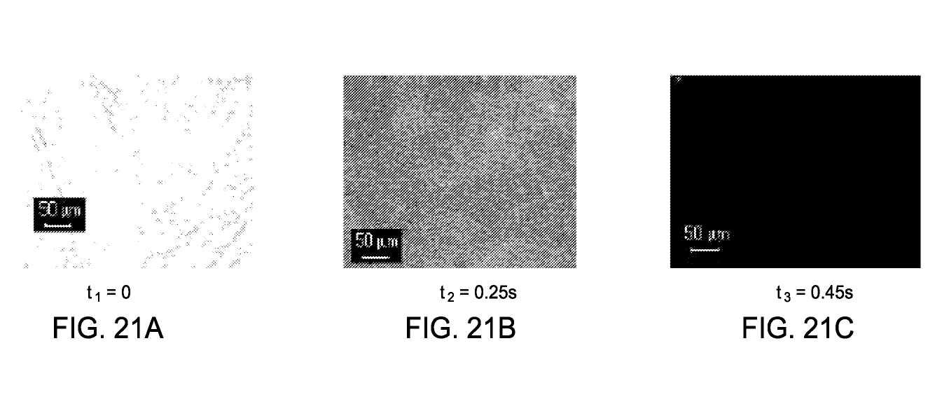

FIG. 21 is a single pixel-level color changes in the display device. (Optical micrograph at 160× magnification). The pixel color change indicated in the figure above has very good display properties, measured and obtained from the source. The table below illustrates the display properties of such a display.

TABLE 2
summarizes the basic display properties of the present invention.

| Display Property | Value (units) |
|---|---|
| Contrast Ratio | 15 |
| Reflectivity | Paper-like (white state) |
| Switching rate | 400 ms |
| Voltage Consumption | 2.5 (1% moisture) and 6 V (dry) |
| Bistability | 10 min (1% moisture) and 30 min (dry) |
| Electronic impulse | 1-2.4 V |
| for color change | |
| Power Consumption | 0.025 mW (across 1 × 1 cm²) |
| Color Presentation | Monochromic (two states of dye) |

Hence, the display element indicated in can be integrated in two ways to make a full-scale device: (1) top-bottom approach (already illustrated in the patent); and (2) the in-plane approach—this will have BC material as the top-membrane and is illustrated in the following section.

The horizontal “in-plane” switching approach. FIG. 22 is a top view of an integrated device structure for displaying alphanumeric characters on the in-plane electronic paper prototype (field lines & direction are indicated). The second device structure which has been studied has both electrodes on the bottom side. If this device structure were to be integrated into a full scale working model, then a recently developed in-plane drive circuit (e.g., a Hitachi in-plane electronic drive circuit) may be used to integrate such a device into a fully functional prototype. This technique was developed primarily to impart high viewing angle capabilities to existing LCD technologies. Briefly, instead of active transistors addressing each pixel in the top-bottom device, here there will be two adjacent lines connecting vertical and horizontal electrodes to control what is displayed on a particular pixel. A simple schematic of displaying an alphabet on an in-plane 3×3 matrix is illustrated (FIG. 22).

Crossing vertical and horizontal lines patterned on the substrates are then addressed using a drive. Vertical lines create the potential gradient of +/−2.5V, and horizontal lines ground the target pixels for them to realize the vertical field. The two adjacent lines by creating a horizontal field can reduce the dye in the membrane at a pixel or oxidize it to produce an ON or OFF state. In the above case two horizontal lines are grounded and hence the six pixels in the bottom rows are influenced by the electric fields due to the three vertical lines (potentials indicated in the FIG. 22).

Thus, the horizontal fields can be drawn from positive to negative potentials. These horizontal fields then deplete the two pixels in the left column and rightmost column and charge the dye in the center two pixels. The entire bacterial cellulose film will be addressed line-by-line horizontally. Hence, if the top row of dyes has been colored by a previous operation, the 3 top pixels will remain colored if their horizontal line stays on float. (Wherever the horizontal lines are held on float; field effect does not take place; FLOAT=not connected to circuit or no potential applied). Therefore, as illustrated above, alphanumeric characters can be displayed on a 3×3 pixel matrix. The system can be scaled up to a 680×340 pixels which can create a full-scale display.

Advantages of this device, in comparison to the top-bottom one include the following. (1) Bacterial cellulose will be the top film of this device. Therefore, the optical properties achieved can be far superior to other available devices. The display will have the exact optical properties as well as the touch and feel of paper. (2) The switching rate can be increased in this device by patterning the bottom side with nanostructured patterns on the electrode to functionalize the dye. Also, since the field does not have to travel through the entire membrane thickness, the switching should be rapid. (3) The thickness of the bacterial cellulose film, the size and orientation of the cellulose microfibrils therein, and the degree of crystallinity, all can be controlled during synthesis, making the surface of the paper optimized for electronic integration.

One type of electronic paper unit can use individually addressed by a field effect transistor (FET) (such as an n-FET). The FET uses a ground and a bottom and top electrode. This is also the active matrix addressing scheme whereby each transistor individually addresses a pixel. The bottom electrode is addressed directly by an n-field effect transistor. The transistor in the bottom can in fact also be a silicon thin film transistor or an organic transistor.

A simple addressing scheme is proposed for a picture element of the device in an active matrix with a transistor (in this case an n-FET) attached to the electrochromic pixel on the bacterial cellulose membrane. In operation, the bacterial cellulose membrane can be placed over a patterned active matrix TFT circuit. Charging of each pixel can create images. All transistors in the array are individually addressable in a row/column format. The transistor circuits retain the state (on/off) and level (intensity) information programmed by the display electronics. X, row and column Y, then send down the potential across the desired transistor. X and Y columns are addressed by software-controlled ICs.

Another common display drive circuit is the passive matrix. It is a much simpler system than the active matrix. Passive-matrix schemes use a simple grid to supply the charge to a particular pixel on the display. It usually starts with two glass layers with an optical film cased in between. One substrate is given columns and the other is given rows, both made from a transparent conductive material. This is usually indium-tin oxide (ITO). The rows or columns are connected to integrated circuits that control when a charge is sent down a particular column or row. To turn on a pixel, the integrated circuit sends a charge down the correct column of one substrate and a ground activated on the correct row of the other. The row and column intersect at the designated pixel, and that will color the dye at that point.

In both passive-matrix and active-matrix displays, the pixels on the screen are addressed one row at a time via the row electrodes. During each row-addressing period, the individual pixels in the row are switched on or off by appropriate voltages on the column electrodes. The passive matrix system has significant drawbacks notably slow response time and imprecise voltage control. The light output of each pixel is controlled continuously by active matrix, rather than being “pulsed” with high currents just once per refresh cycle (passive). Active-matrix displays are more expensive than passive matrix, but they boast brighter, sharper images and use less power. Hitachi in-plane switching technique proposed for the in-plane bacterial cellulose device is a modification of active matrix technique and depends on TFT to modulate and control the pixel.

The following flexible display techniques may be used with the present invention: (1) silicon transistors on steel foils; (2) organic Transistors on polyimide surfaces; and (3) patterned ITO coated flexible laminates such as Mylar (http://www.3m.com). Each of the technologies may be adapted suitably to mate with bacterial cellulose membranes. Passive matrix technology provides simplicity and is considered a future flexible display technology especially for bistable optical devices such as one constructed. The passive matrix could be modified to create and an in-plane drive as shown in FIG. 22. Due to current advances, however, active matrix technology will be used for initial prototypes.

Multi-color synthesis. A multicolor prototype of this device will be made using a subtractive color scheme. Subtractive color synthesis uses paints, dyes, inks, and natural colorants to create color by absorbing some wavelengths of light and reflecting or transmitting others. The complementary colors are the control colors of subtractive color synthesis; thus, the dyes in color filters and emulsions, and the inks (process colors) used in photomechanical reproduction are cyan, magenta, and yellow. A single complementary color produces its own color. Two complementary in equal strengths produce a primary color because each absorbs a primary, e.g., magenta and yellow absorb green and blue, respectively, leaving red to be observed. Combinations of unequal subtractive strengths produce intermediate colors from white light. To synthesize the complementary colors, relevant elecrochromic dyes have to be adapted into the prototype. The color options available with electrochromes are illustrated in Table 3.

TABLE 3
Various categories of Electrochromic dyes and colored states.

| Class | Electrochromes | Color States |
|---|---|---|
| Transition metal | | Transparent/blue |
| oxides WO₃ | | |
| | NiOxHy | Green/black |
| | V₂O₅ | Yellow/blue |
| Prussian Blue | iron hexacyano- | White/Blue/Brown/Green |
| | ferrate | |
| Viologens | methyl viologen | Blue-purple |
| Conducting polymers | Polyaniline | Yellow/green/blue-black |
| | Polypyrrole | Blue-violet |
| | PEDOT | Sky blue/Deep blue |
| Metal pthalocyanines | lutetium bis- | Blue/green |
| | phthalocyanine | |

Along with methyl viologen; successful incorporation of, e.g., Prussian Blue and PEDOT can enhance color options. Similar success was achieved with various other electrochromic systems (e.g., Prussian Blue and polyaniline), which may be incorporated alone or in combination with the above. Techniques such as spin coating or ink-jet printing can be employed for these. In addition, an intermediate control over grayscale has been demonstrated. Therefore, the present invention includes a combination of the above dyes in a multi-color display with gray scaling possible with this concept. Gray scaling may be achieved using additional dyes or by switching the voltage back and forth, not unlike gray-scaling obtained by fluttering the mirrors in a digital light processor (e.g., Texas Instruments' DLP® micromirror array). In fact, the underlying circuitry and signal used for micromirror arrays may be used in conjunction with the present invention.

The present invention may also be used in conjunction with radio frequency modulation of one or more integrated circuits in contact with one or more variable intensity dyes. For example, the integrated circuits may be set out in one or more pixels, e.g., a pixel array. In this embodiment, rf energy of specific frequency can be directed at the entire object (e.g., an art canvas) but only one pixel in that entire painting may be addressed and changed by the specific frequency transmitted. The rf energy may be a continuous signal, a pulsed signal or one modulated by a code to address one or more pixels. As will be apparent to the skilled artisan of rf activation, the one or more pixels may be activated using a single, multiple or various energies of activation. For example, a handset may be used to as a transmitter with the circuitry that permits a frequency scan to transmit at, e.g., millions of different frequencies. The result is that all pixels in the painting are signaled, alone, in combination, in series, in parallel or all at once.

In this embodiment, one or more specific antennae may be connect or associated with one or more pixels, or even with wordline and bitlines that may address combination of pixels to activate or deactivate the intensity of the one or more dyes. The pixels may be formed in, e.g., triads to permit for activation of different colors at very high resolutions. Depending on the level of resolution, the design of the array, the type or number of color(s) the number of frequencies is selected specifically receive a very sharp, a moderate or even overlapping bandwidths. In certain embodiments, the overlapping frequencies may be modulated, e.g., using time dependent multiple access (TDMA), code dependent multiple access (CDMA), combinations and/or derivatives thereof or even other known or future methods of signal deconstruction and reconstruction. In one embodiment, simple loop antennae may be used. Using the cellulose substrate of the present invention, it is possible to create concentric graphene sheets in graphite that is formed, crystallized or deposited such that they serve as loop antennae. Another example, which is not mutually exclusive with the use of grapheme sheets, is the use of one or more single walled nanotubes or multiple walled nanotubes micro- or nano-fabricated into antennae.

In one specific example, a NQ-5 strain, which synthesizes cellulose ribbon reversals, which may be used for building electronic paper with one or more of the following features: (a) multi-cabled ribbons of cellulose microfibrils may produce a stronger framework in which to bind the electrochromic dyes and conductors; (b) parallel ribbons made by the reversal in the direction of synthesis may produce different or better interactions between the dyes and the surface of the cellulose. In one embodiment, the parallel ribbons may be used for optimal alignment and binding of the electrochromic dye molecules.

One such RF-ID system for use in the context of the individually addressable cellulose system of the present invention is described in U.S. Pat. No. 5,053,774, issued to Schuermann, and assigned Texas Instruments, relevant portions incorporated herein by reference. The patent teaches a transponder arrangement that includes an interrogation unit that sends a radio frequency (rf) interrogation pulse to at least one responder unit. The responder unit then transmits back data stored therein in the form of a modulated rf carrier to the interrogation unit. An energy accumulator in the responder unit stores the energy contained in the rf interrogation pulse. The responder unit may initiate activation of the dye variation, generally once sufficient rf energy is stored and the correct frequency contained in the RF interrogation pulse. The output signal of the RF carrier wave generator generates the dye variability control signal that is used to modulate the dye to or from its maximum intensity.

The RF-ID system may be incorporated into a support matrix for the dyes and conducting elements, which may or may not be cellulose chemically. For example, the present invention may be used with one or more combination of cellulose derivatives, e.g., cellulose acetate, cellulose butyrate, carboxymethylcellulose, carboxyethylcellulose, methyl cellulose and even nematic ordered cellulose (NOC). NOC may be particularly useful in certain applications because its ordered and non-crystalline, which allows for a greater surface area for dye incorporation (greater than with crystalline cellulose). NOC may even be used as a coating on a crystalline microbial cellulose substrate, which gives added strength plus greater surface area for binding the dyes. Furthermore, the cellulose derivatives may be formed into substrates that allow more precise binding of the specified electrochromic dye. Also, the cellulose may be or include one or more cellulose allomorphs, e.g., cellulose I (the native crystalline form), cellulose II (=rayon), a regenerated crystalline form; cellulose IV (a low crystallinity cellulose) or combinations thereof.

The cellulose substrate and addressable pixels of the present invention may find usefulness beyond paper, for example, as a high definition paper. Presently, the size of the finest photographic negative uses silver halides, which are around 14 microns. Using the cellulose substrate of the present invention, a high resolution substrate may be made for use in displaying on a paper or paper-like substrate with high definitions. High definition paper is achieved using the present invention because of the nanometer range diameter of the cellulose microfibril ribbons generated by Acetobacter. Using Acetobacter formed paper and small molecule sized dyes, e.g., variable intensity dyes, the present invention can have a resolution from 10 to 100 times better than the best photographic resolution, that is 1.6 or even, 0.16 microns. The high definition paper of the present invention may find uses for high resolution, high density cellulose storage of images. These high resolution, high density images may require use of a high definition paper microscope or reader that provides magnification well above the resolution of the unaided human eye (around 200 microns). Using these special high definition “readers” or “magnifiers” (e.g., analog or digital) the high definition paper would provide a high storage density, microfiche or data storage capability without the need for plastics or film, provide higher resolution, are not dependent on harsh or toxic chemicals and processing and provide a the highest contrast possible (unlike microfiche which is generally see-through, scratches and degrades). In one embodiment, the high resolution paper uses quantum dots as the dye. In yet another embodiment, the cellulose may be coated with a high electron density material, e.g., uranium and the high resolution storage information is coded onto the surface by etching, darkening or bleaching locations along the length on an individual nanofibril using an ion beam, X-ray or laser. The data is recovered using, e.g., a TEM, SEM, Raman spectroscopy that is connected to an automated reader using, e.g., scanning software.

Furthermore, the strength, durability and safety of the high definition paper may be further enhanced by the use of simple chemicals for protection, e.g., fluoride-based chemicals such as perfluorooctane sulfonates (e.g., scotchguard), which may not be used with normal plastic-based film. Using these perfluorooctane sulfonates to protect the cellulose substrate, regular film deposition may be conducted on the cellulose substrate paper with enhanced strength, durability and protection (e.g., from dirt, humidity, water, etc.) in the form of a microfiche or other high density and high contrast storage. To improve the resolution, binding and the like, conducting elements may be incorporated into the cellulose. In addition to, e.g., single walled nanotubes, sheets and the like, the cellulose may be conductively or ionically doped in situ, before, during or after synthesis, with lithium, sodium, metals or other ionic salts to improve conductivity while maintaining the hygroscopic properties to a minimum. Alternatively, the final cellulose surface layer may be coated with a fluorinated polymer to prevent moisture absorption, to keep the surface somewhat hydrophobic and easier to clean with a damp cloth. The extent of doping may be selected for, incorporation of integrated circuits, e.g., lightly dopes drains (LDDs), for a broad “doping” range with many types of conducting elements ranging from electrically conducting polymers to graphite, to silver nanoparticles (even quantum dots), etc., that are integrated into the cellulose matrix and may be used to attract or repel ions. In one example, the cellulose may be doped, a charge applied to act as, e.g., a cathode or anode, and a particle beam of opposite charge used to “write” on the cellulose substrate at the atomic level, e.g., for high definitions paper that combines high storage capacity and the high contrast provided by cellulose.

In one embodiment, the cellulose substrate is formed in medium that includes nanoparticles, e.g., carbon nanotubes, sheets, cones, balls, and the like, add to the growth medium such that they are incorporated into the growing cellulose membrane as it is being synthesized by the bacteria. The cellulose membrane is generated by synthesis of random or even ordered ribbons at the gas liquid interface, in which the nanoparticles are in suspension in the growth medium and bind to the ribbons as they are synthesized. The cellulose may also be grown in the presence of, e.g., Tinopal or Calcofluor to the growth medium and this delayed crystallization (but not polymerization) (see e.g., Haigler, C., R. M. Brown, Jr. and M. Benziman. 1980. Calcofluor White ST alters the in vivo assembly of cellulose microfibrils. Science 210:903-906 (cover), relevant portions incorporated herein by reference) for inclusion of conducting ions or even nanoparticles.

The present invention may be used in the form of a single membrane or even multiple cellulose membranes bonded to each other to provide, e.g., two or even three dimensional storage when using partially translucent cellulose. When used as a multi-layered substrate, optimal dye cellulose interactions may be selected to maximize the use of the cellulose substrate as a functional electronic paper.

For use with, e.g., magnetochromic dyes, such as cholesterol-based dyes, the present invention may use the widely available infrastructure available from Xerox developed for rotatable magnetic fields, commonly referred to as gyricon. The gyricon technology may be used as the underlying basis for the integrated circuits and connections that underlie the electronic paper of the present invention, thereby taking advantage of known technology (see e.g., U.S. Pat. No. 6,690,350, Sheridon, et al., relevant portions and references cited therein incorporated herein by reference, including, without limitation those patents issued with Nicholas Sheridon as an inventor) with the high contrast fibrous organic substrate or cellulose substrate of the present invention. Briefly, the rotatable elements of the gyricon technology are replaced with an overlay of the display system of the present invention. One distinct advantage over the gyricon technology is that using the variable intensity dyes disclosed herein on the cellulose substrate energy only has to be applied for a time sufficient to change the intensity of the dye and energy is no longer required. Another advantage is that the use of, e.g., cellulose, permits the user to enjoy the contrast provided by a paper or paper-like product with the dye.

The selection, isolation, characterization and sequence of semiconductor template peptides are taught in U.S. Patent Application 20030113714, filed by Belcher, et al., relevant portions, sequences, techniques, libraries and conditions for semiconductor formation incorporated herein by reference. Belcher and her colleagues have developed methods for biological control of nanoparticles that include compositions and methods for selective binding of amino acid oligomers to semiconductor and elemental carbon-containing materials. The method includes controlling the particle size and identity of a semiconductor or elemental carbon-containing material by interacting with the semiconductor template peptide that binds specifically to the material with solutions and under conditions that result in the formation of the semiconductor material, e.g., quantum dots. The same method may be used to control the aspect ratio of the nanocrystal particles of the semiconductor material. Alternatively, the peptides may be used to trap or capture, with very high specificity pre-made nanoparticles or materials (e.g., carbon nanotides) to create nanowires from the semiconductor or elemental carbon-containing material. Using the cellulose substrate of the present invention in conjunction with the semiconductor template peptides, the strong, renewable, biodegradable, high contrast, cellulose substrate of the present invention can be used to create the high and ultra high definition paper of the present invention. An ion beam or x-ray can be used using the quantum dots.

Yet another embodiment of the present invention is a cellulose display device built on or about the surface of a micromirror-array bidirectional memory array architecture. The cellulose substrate-variable intensity dye system of the present invention may be placed on-top of a memory cell with a polysilicon-to-substrate storage capacitor, the memory cell, e.g., a single complementary metal oxide semiconductor (CMOS) transistor having an inherent junction capacitor and electrically connected to the polysilicon-to-substrate storage capacitor that are addressed by a bit-line providing data to the memory cell and a word address line. The cellulose substrate comprising one or more variable intensity dye regions is placed with the regions generally at, about or over the transistors that provide the changes in voltage to change the dye intensity of, e.g., an electrochromic dye. In one specific embodiment, reset electrodes may be positioned by the one or more variable intensity dye regions.

The underlying semiconductor architecture, methods and making and software and coding for operations will be known to those of skill in the art based on the description of prior art and the disclosure of U.S. Pat. No. 6,775,174, by Huffman, et al., and assigned to Texas Instruments, relevant portions, figures, description, circuitry and the like incorporated herein by reference. By using an opaque cellulose substrate, the present invention overcomes one of the issues addressed by Huffman, namely, the light sensitivity of the capacitors. The present invention may be used with the prior art bidirectional devices or more modern versions that incorporate the higher capacitance. Regardless, the energy usage of the present invention may be negligible in comparison with the standard mirror arrangement based on the usage, number of changes, etc. Furthermore, the present invention may even be used in conjunction with a micromirror array as an overlay or complementary surface. As incorporation of integrated circuits with the conductive, doped and non-conductive cellulose substrates of the present invention (as described hereinabove) matures, the present invention may be used with the transistor and array designs, voltages, capacitance and addressing methods and systems presently used in known micromirror array systems.

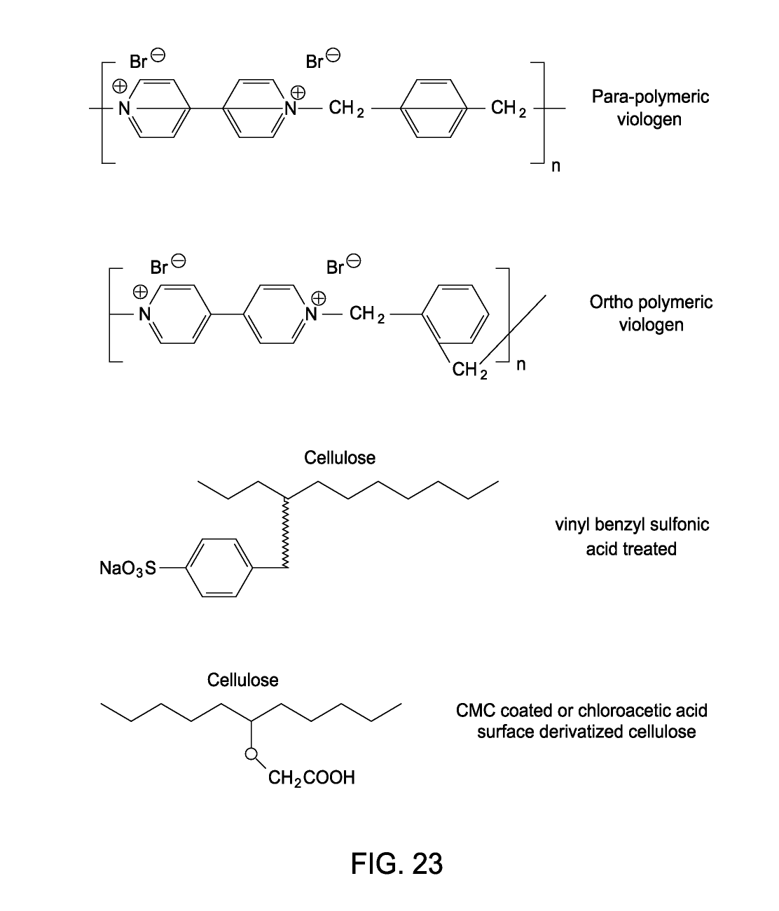

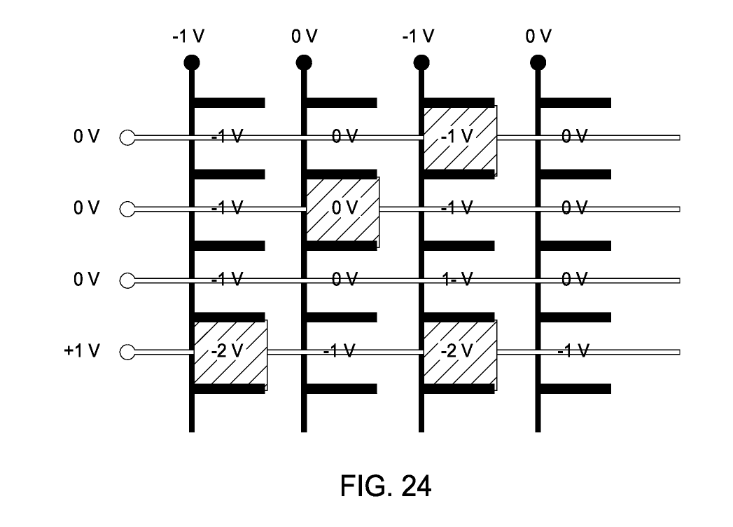

FIG. 23 and the following examples show the structures and include several methods of chemically binding a dye to the substrate. The substrate may be, e.g., a multiribbon cellulose, a conductive cellulose, a carboxymethylated cellulose, one or more cellulose allomorphs or sub polymorphs and/or mixtures and combinations thereof. For example, combinations or mixtures of pure bacterial strains may be combined at different ratios to control the type and/or shape of the final cellulose.

In some cases, the strains may be added or combined at different time and/or the strains may be combined but one or more metabolically required nutrients may be added or removed to trigger the formation of different types or shapes of cellulose at different times and/or locations, e.g., in horizontal layer, vertical layers, diagonal layers and/or combinations thereof. Examples of strains for use with the present invention are well known in the art, e.g., U.S. Pat. No. 4,954,439, issued to Brown, Jr., et al., entitled “Multiribbon microbial cellulose,” relevant portions incorporated herein by reference. The cellulose substrate may also be modified chemically during and/or after manufacture. Alternatively, different portions of the cellulose substrate may be assembled in situ by one or more bacterial strains and/or mechanically assembled after manufacture and combinations thereof.

### EXAMPLE 1

Chemical binding of electrochromic dyes onto microbial celluloses. Step 1: Equimolar amounts of 4,4′-bipyridyl and α,α′-dibromoxylenes were reacted in dry acetonitrile, DMF, DMSO, NMP, ethanol, methanol, or acetone in 0.5%-30% concentration at 20-100° C. for 30 min-24 h. After reaction, the products were filtered, washed with acetone, ethanol, or methanol, and dried. Step 2: Microbial cellulose was reacted with chloro-acetic acid aqueous solution (0.1%-30%) in the presence of a base or base mixtures such as NaOH, KOH, Na₂CO₃, etc., at 20-100° C. for 1 min-24 h. After reaction, the cellulose samples were washed with distilled water.

Step 3: Products from step 1 were dissolved in water (0.1%-10%). Cellulose samples prepared according to step 2 with or without drying were immersed in the solution at 20-100° C. for 1 min-24 h. After reaction, the cellulose samples were washed and dried at 20-200° C.

### EXAMPLE 2

Chemical binding of electrochromic dyes onto microbial celluloses. Step 1: Equimolar amounts of 4,4′-bipyridyl and α,α′-dibromoxylenes were reacted in dry acetonitrile, DMF, DMSO, NMP, ethanol, methanol, or acetone in 0.5%-30% concentration at 20-100° C. for 1 min-24 h. After reaction, the products were filtered, washed with acetone, ethanol, or methanol, and dried. Step 2: Microbial cellulose was reacted with cellulose, carboxymethyl ether (CMC) aqueous solution (1%-30%) in the presence at 20-100° C. for 30 min-24 h. After reaction, the cellulose samples were washed with distilled water. Finally, in step 3: Products from step 1 were dissolved in water (0.1%-10%). Cellulose samples prepared according to step 2 with or without drying were immersed in the solution at 20-100° C. for 1 min-24 h. After reaction, the cellulose samples were washed and dried at 20-200° C.

### EXAMPLE 3

Chemical binding of electrochromic dyes onto microbial celluloses. Step 1: Equimolar amounts of 4,4′-bipyridyl and α,α′-dibromoxylenes were reacted in dry acetonitrile, DMF, DMSO, NMP, ethanol, methanol, or acetone in 0.5%-30% concentration at 20-100° C. for 30 min-24 h. After reaction, the products were filtered, washed with acetone, ethanol, or methanol, and dried. In step 2: Microbial cellulose was reacted with a polymerizable acid such as acrylic acid, vinyl styrenesulfonate, etc., aqueous solution (0.1%-30%) in the presence of an initiator (eg., K₂S₂O₄, Na₂S₂O₈, (NH₄)₂S₂O₈, etc.) at 40-150° C. for 1 min-24 h. After reaction, the cellulose samples were washed with distilled water. Finally, in step 3: Products from step 1 were dissolved in water (0.1%-10%). Cellulose samples prepared according to step 2 with or without drying were immersed in the solution at 20-100° C. for 1 min-24 h. After reaction, the cellulose samples were washed and dried at 20-200° C.

### EXAMPLE 4

Chemical binding of electrochromic dyes onto microbial celluloses. Step 1: Equimolar amounts of 4,4′-bipyridyl and alkyl halogens (CH₃(CH₂)ₙX, n=0-10, X=I, Br, or Cl) were reacted in dry acetonitrile, DMF, DMSO, NMP, ethanol, methanol, or acetone in 0.5%-30% concentration at 20-100° C. for 30 min-24 h. in 0.5%-30% concentration at 20-100° C. for 30 min-24 h. After reaction, the products were filtered, washed with acetone, ethanol, or methanol, and dried. Step 2: Products from step 1 were reacted with a halogenated amino salt (X(CH₂)ₙNH₂HCl, X=I, Br, or Cl, n=2 to 10; or X-Ph-NH₂HCl, X=I, Br, or Cl) in dry acetonitrile, DMF, DMSO, NMP, ethanol, methanol, or acetone in 0.5%-30% concentration at 20-100° C. for 30 min-24 h in 0.5%-30% concentration at 20-100° C. for 30 min-24 h. After reaction, the products were filtered, washed with acetone, ethanol, or methanol, and dried. Step 3: Products from step 2 were reacted with cyanuric chloride in acetonitrile, DMF, DMSO, NMP, acetone, THF or water in 0.5%-30% concentration at 0-50° C. for 30 min-24 h under a pH of 5-7. After reaction, the products were filtered and were filtered, washed with acetone, THF, or ethyl acetate, and dried. Finally, step 4: Products from step 3 were dissolved in water (0.1%-10%). Microbial cellulose samples were immersed in the solution at 20-100° C. for 1 min-24 h. After reaction, the cellulose samples were washed and dried at 20-200° C.

In-Plane Switching (IPS) was first demonstrated by Hitachi as a way to impart a horizontal electric field on liquid crystal displays in order to increase angle of view in LCD flat panel displays (see, e.g., http://www.meko.co.uk/ipswitch.shtml, relevant portions incorporated herein by reference). A basic circuit layout is disclosed herein for an IPS address of an array from the backside of electronic paper:

FIG. 24 shows the design for an in-plane switching mechanisms for use with the present invention. The IPS as shown may be used for electrically switching electronic paper, which allows for not only increasing the angle of view but also to eliminate the front electrode on the paper so the viewer can view the electronic paper as one would view regular paper. The IPS provides a real paper viewing experience without the glare, a major source of eye fatigue when viewing electronically displayed information.

In operation the circuit shown in FIG. 24 may be operated as follows: the In-Plane Array driver circuit the full array is first “cleared” to the “white” paper state by applying frame reset pulses (−1 volt row pulses, +1 volt column pulses). Next, one row at a time is addressed using a +1 volt row pulse and simultaneously applying “data” pulses to the columns, i.e., 0 volts to leave the paper pixel white (or colored, if already colored) and −1 volt pulses to change the paper pixel to its colored state. Thus, the pixels receiving “−2 volts” in the addressed row (+1 volts) will switch to their colored state; those receiving just “−1 volts” will remain unchanged. The IPS scheme requires that the electronic ink (colorant) has a threshold and is bistable, i.e., the ink switches only when a voltage greater than the threshold voltage, e.g. −1 volt in this example, is applied across the pixel. Lower or higher threshold voltages could be used by simply adjusting the voltages in the example, selecting other dyes, modifying the thickness of the substrate, etc. A threshold voltage of between 1 and 2 volts has been shown to produce the expected results. For bistability, the ink will generally remain in the colored or white state for one frame time, i.e., until the next frame reset. This operation is similar to addressing memory. It has been demonstrated that memory time of the order of several minutes or longer is achieved with the present invention and IPS circuitry.

In one example, the Horizontal Row Lines are insulated from Vertical Column Lines, e.g., may be coated on opposite (top) side of backplane drive layer. The Electrochromic Dye at Row-Column Crosspoints Switches Color State on Activated Row (+1 V) only according to Column Data Pulses (−IV). Finally, the Frame Reset may occur before every Frame Write using a −1 V Row and +1 V Column Pulses. Rows may receive a “Line-at-a-Time” Address Pulses (+IV) from common LCD Row Driver Circuitry.

In order to implement a backside only address circuit, several conductive materials (gold, nickel, titanium, silver) have been or may be deposited onto the backside of, e.g., microbial cellulose paper (7-day paper ˜80 microns dry thickness). For example, the gold is vacuum deposited, 40 nm thick, through a shadow mask (thin metal sheet with parallel line openings through which the evaporated gold atoms go and deposit onto the underlying MB paper which lies under the mask) as are well-known to the skilled artisan.

The gold lines were found to be highly conductive, >50,000 S/cm, with sheet resistivity of <5 D/sq for a 40 nm thick film. This level of conductivity is sufficient to support video rate imaging at a 1000 lines of resolution. In the circuit, the lines may be deposited at, e.g., 8 lines per inch (lpi) although shadow mask technique may be used to provide up to about 50 lines per inch (lpi). For higher line density direct printing, digital optical chemistry processing or photographic techniques may be used.

To test the above line array, the paper substrate onto which an electrode had been deposited or printed was placed in an aqueous solution that included 5% methyl viologen to 3% lithium chloride, partially dried (to a damp state), and +2 and −2 volts were applied to adjacent lines. The viologen colorant switched from white at the positive electrode to deep violet at the negative electrode. A stable state that would last several minutes was observed for the switch. Alternating, light-to-dark, switching was achieved by applying a square wave signal alternating between +2V and −2V at a switching frequency of 2 Hz.

Several other vacuum deposited metals were deposited in the above manner as well: Nickel (conductive on multicellulose paper, which may be used instead of gold); Titanium (not conductive on MC paper but was conductive as deposited onto smooth polyester film, a 40 nm titanium metal film on the paper oxidized to TiOx in air and became nonconductive); and Silver (also non-conductive).

In FIG. 25 a cross-section view of a pixel array is shown (as opposed to a line array) in which the electrode lines are placed on two sides of a very thin multicellulose paper, e.g., a multiribbon cellulose paper made using the NQ-5 strain. The two-sided electrode made be made on a very thin substrate, e.g., <10 microns, such that it acts like an “in-plane switch” when laminated to the backside of, e.g., a thicker electronic paper. Thus, a two-layer electronic paper may be laminated as one sheet: the top layer would be the switchable multicellulose paper with its colorant, and the bottom layer would be this very thin, two-sided “In-Plane Switch” circuit.

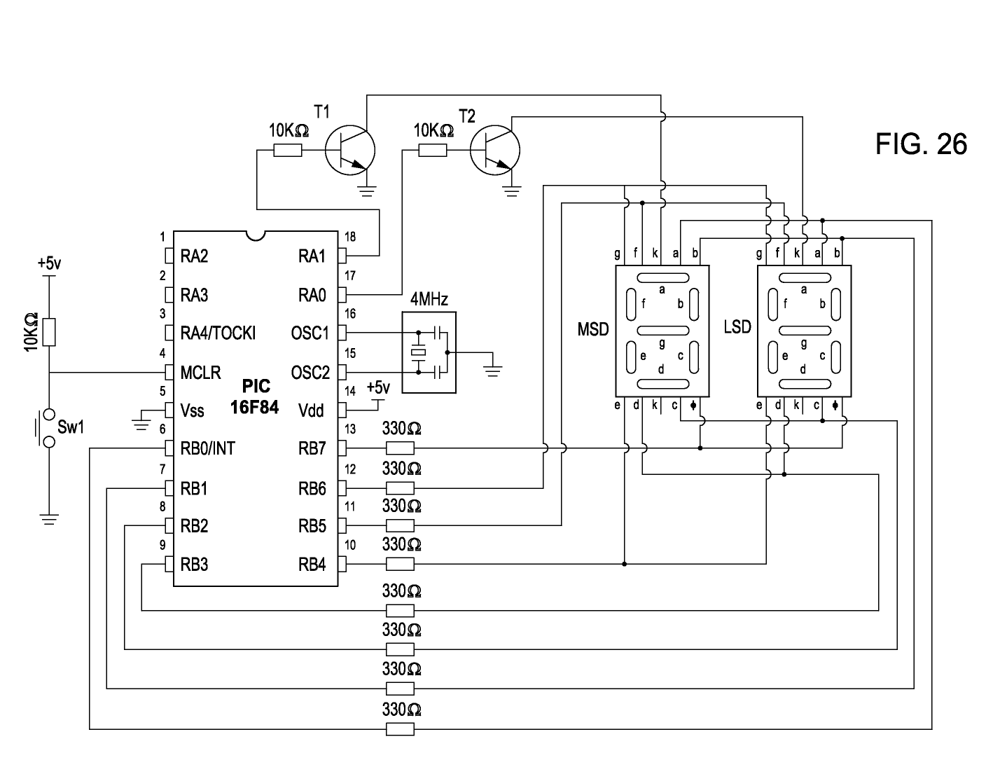

As shown in FIG. 26, the present invention may be formed into a small pixilated or 7-segment display, depicted below showing an “8” (e.g. used to make a sign element such as letters or numbers) under the control of a driver chip, e.g., a PIC Microcontroller (see, e.g., M. Oh-e, M. Ohta, S. Aratani, and K. Kondo, “Principles and Characteristics of Electro-optical Behavior with In-Plane Switching Mode”, IDRC '95 (Asia Display '95), (1995) 577-81; and K. Kondo, K. Kinugawa, N. Konishi, H. Kawakami, “Invited Paper: Wide-Viewing-Angle Displays with In-Plane Switching Mode of Nematic LCs Addressed by 13.3-in. XGA TFTs”, Society for Information Display, SID Digest (1996), 1-5; relevant portions incorporated herein by reference).

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A display device comprising:
a biodegradable multi-ribbon cellulose substrate;
one or more variable reflectivity dyes embedded in or on the substrate, wherein the reflectivity of the dye is modulated in situ by an electromagnetic source; and
a control logic that controls one or more electromagnetic sources, wherein the output from the one or more electromagnetic sources changes the reflectivity of the one or more dyes.

2. The display device of claim 1, wherein the dye comprises an electrochromic, a thermochromic, a magnetochromic, an ionochromic, a light sensitive, a fluorescent, a fluorescent effect energy transfer dye or combinations thereof and the one or more electromagnetic source produces are matched to change the reflectivity of the respective one or more dyes.

3. The display device of claim 1, wherein the multi-ribbon cellulose substrate is made by Acetobacter xylinum strain NQ-5.

4. The display device of claim 1, wherein the substrate comprises a carboxymethylcellulose, a methylcellulose, a hydroxyethylcellulose, a hydroxypropylcellulose, a hydroxypropylmethylcellulose, mixtures or combinations thereof.

5. The display device of claim 1, further comprising a non-biodegradable passivation layer disposed on or about the substrate.

6. The display device of claim 1, wherein the substrate is optically opaque.

7. The display device of claim 1, wherein the reflectivity of the dye is modified with an electric field.

8. The display device of claim 1, wherein the reflectivity of the dye is modified with an electric field of between about −5 to about +5 volts.

9. The display device of claim 1, wherein the dye comprises a dialkyl derivatives of 4,4′-bipyridinium salts, WO₃, MoO₃, Prussian blue (PB, ironIII-hexacyanoferrate II), tetrathiafulvalene (TTF), V₂O₅, Nb₂O₅, TiO₂, IrO₂, NiOₓ, CO₂O₃ or combinations thereof.

10. A system for changing the display information on a multi-ribbon microbial cellulose substrate that has been embedded with one or more electrochromic dyes, the system comprising:
an electric field generator in communication with a control logic; and
a mechanism for progressively moving the electric field generator in relation to the substrate, wherein one or more electric fields that emanate from the electric field generator change the optical absorption characteristics of the electrochromic dye.

11. The system of claim 10, wherein the electrochromic dye is modified with an electric field of between about −5 to about +5 volts.

12. The system of claim 10, wherein the substrate is optically opaque.

13. The system of claim 10, wherein the substrate comprises a multi-ribbon cellulose produced by Acetobacter xylinum strain NQ-5.

14. The system of claim 10, wherein the electric fields are formed by emitters embedded in or about the substrate.

15. The system of claim 10, wherein the substrate further comprises a passivation layer disposed on a display surface of the substrate.

16. The system of claim 10, further comprising a transceiver in or about the substrate in communication with the control logic.

17. The system of claim 10, further comprising a power source connected to, in or about the substrate connected to the control logic.

18. The system of claim 10, further comprising a power source comprising a paper battery connected to the control logic.

19. The system of claim 10, wherein the electric field is generated by a remote emitter.

20. The system of claim 10, wherein the electric field generator comprises a printer head and the mechanism for moving the electric field in relation to the substrate is a printer.

21. The system of claim 10, wherein the substrate comprises an electrically conductive cellulose and the control logic is formed in the substrate.

22. A rewritable display system comprising:
a multi-ribbon cellulose substrate;
an electrochromic dye covalently attached to the substrate, and
an electric field generator in communication with the substrate, wherein the generator produces an electric field with sufficient energy to modulate the light absorption characteristics of the dye.

23. The system of claim 22, wherein the substrate comprises a rewritable surface, a map, a wallpaper, a street sign, a billboard, a newspaper, a book, a computer screen, a wall, an electronic book, a storage device, a display, a high resolution display, a sheet or combinations thereof.

24. A cellulose display device comprising:
a biodegradable multi-ribbon cellulose substrate comprising one or more electrochromic dye regions;
a memory cell with a polysilicon-to-substrate storage capacitor, the memory cell comprising:
a single CMOS transistor having an inherent junction capacitor and electrically connected to the polysilicon-to-substrate storage capacitor;
a bit-line providing data to the memory cell;
a word address line; and
an electric field generator controlled by the memory cell, wherein the generator produces an electric field with sufficient energy to modulate the light absorption characteristics of the dye.

25. An in-plane switching device comprising:
a biodegradable multi-ribbon cellulose substrate having a first and a second surface onto which one or more variable intensity dye regions have been bound and at least one conductive pattern is deposited on each of the first and second surfaces, wherein the light absorption characteristics of the dye are modified when the device is exposed to an electric field created between the conductive patterns on the first and second surfaces.

26. The device of claim 25, wherein the conductive pattern is an array of conductive patterns, each pattern addressable separately by a control logic.
